(19) United States
(12) Patent Application Publication
(10) Pub. No.: US 2019/0286238 A1
(43) Pub. Date: Sep. 19, 2019

(54) TOUCH PANEL-EQUIPPED DISPLAY DEVICE

(71) Applicant: NIDEC SANKYO CORPORATION, NAGANO (JP)

(72) Inventors: Akihiro YAHATA, Nagano (JP); Tadashi TAKEDA, Nagano (JP); Hiroshi KITAHARA, Nagano (JP); Jinichi ITO, Nagano (JP)

(73) Assignee: NIDEC SANKYO CORPORATION, NAGANO (JP)

(21) Appl. No.: 16/345,235

(22) PCT Filed: Oct. 17, 2017
(86) PCT No.: PCT/JP2017/037522

§ 371 Date: Apr. 25, 2019

(30) Foreign Application Priority Data
Oct. 27, 2016 (JP) 2016-210179
Oct. 27, 2016 (JP) 2016-210180

(51) Int. Cl. G06F 3/01; G06F 3/044

(52) U.S. Cl. CPC G06F 3/016; G06F 3/045; G06F 3/044

(57) ABSTRACT

A touch panel-equipped display device (100A) includes a display member (120), a light transmitting touch panel (130) arranged to overlap with the display member (120), a panel holder (140A) configured to support the display member (120), and an actuator (1) configured to transmit vibration in an in-plane direction of an input surface (115) to an input member (110) configuring the input surface (115) for the touch panel (130). The input member (110) is supported by the panel holder (140A) via a first elastic member (180A) having at least one of elasticity and viscoelasticity. Further, the actuator (1) is not connected to the panel holder (140A). Therefore, even if an operator strongly presses the input surface (151), the vibration of the actuator (1) can be properly transmitted to a fingertip of the operator.

### TECHNICAL FIELD

The present invention relates to a touch panel-equipped display device capable of vibrating an input surface for a touch panel.

### BACKGROUND ART

Unlike a mechanical input device using a mechanical switch, a touch panel-equipped display device has an advantage that an input screen can be freely configured by software, but has a disadvantage that a feel of performing an input operation cannot be given to an operator. Techniques for vibrating an input surface in accordance with the input operation have been proposed (see Patent Literatures 1 and 2).

In the technique described in Patent Literature 1, vibration is transmitted from an actuator attached via a spacer to a fixed wall, to a movable panel in which a display device and a touch panel are integrated. In the technique described in Patent Literature 2, vibration is transmitted from an actuator fixed to an outer frame, to a touch panel spaced apart from a display device. According to such configurations, it is not necessary to transmit the vibration to the display device, so that it is not possible to efficiently vibrate the touch panel.

### CITATION LIST

### Patent Literature

[Patent Literature 1] Japanese Unexamined Patent Application Publication No. 2007-34991

[Patent Literature 2] Japanese Unexamined Patent Application Publication No. 2003-58321

### SUMMARY OF THE INVENTION

### Problems to be Solved by the Invention

However, in the devices described in Patent Literatures 1 and 2, the actuator is fixed to a panel holder such as the fixed wall or the outer frame. For this reason, for example, there is a problem that when the input surface is pressed strongly, it is necessary to vibrate a side of the actuator together with the panel holder, so that the vibration cannot be properly transmitted to the operator. Further, for example, there is a problem that when the input surface is pressed strongly, the actuator stops vibrating, so that the vibration cannot be properly transmitted to the operator.

In view of the above problems, an object of the present invention (a first invention and a second invention) provides a touch panel-equipped display device capable of properly transmitting vibration to an operator.

### Means for Solving the Problem

To solve the above problems, a first invention is characterized by comprising: a display member; a light transmitting touch panel arranged to overlap the display member; a panel holder configured to support the display member; an actuator configured to transmit vibration in an in-plane direction of an input surface to an input member configuring the input surface for the touch panel; and a first elastic member having at least one of elasticity and viscoelasticity, the first elastic member being connected to the actuator and the panel holder, wherein the actuator is supported by the panel holder via the first elastic member.

In the first invention, the actuator can transmit the vibration in the in-plane direction of the input surface to the input member configuring the input surface for the touch panel, and thus, it is possible for an operator touching the input surface to feel the vibration through the input member. Further, in the first invention, the actuator is supported via the first elastic member by the panel holder, and thus, even if the operator strongly presses the input surface, the actuator, which vibrates independently of the panel holder, can properly transmit the vibration to the operator.

In the first invention, it is preferable that the actuator and the first elastic member are provided to overlap with the input member on a side where the display member is positioned with respect to the input member. According to such a mode, since the actuator and the first elastic member do not exist around the input member, it is easy to adopt a mode in which a peripheral area around the input member is narrowed and a mode in which another member is arranged, for example.

In the first invention, it is possible to adopt a mode in which a plurality of actuators are provided. According to such a mode, it is possible to achieve a mode in which strong vibrations in the same direction are transmitted to the operator by the plurality of actuators, and a mode in which vibrations in different directions are transmitted to the operator by the plurality of actuators.

In the first invention, it is possible to adopt a mode in which when viewed from a direction orthogonal to the input surface, the plurality of actuators are arranged point-symmetrically about a center position of the input member or line-symmetrically about a virtual line passing through the center position. According to such a mode, it is possible to transmit vibration with a sense of creativity to the operator.

In the first invention, it is possible to adopt a mode in which each of the plurality of actuators includes a support body configured to transmit vibration to the input member, a movable body, a second elastic member having at least one of elasticity and viscoelasticity, the second elastic member being connected to the support body and the movable body, and a magnetic drive circuit configured to drive the movable body relative to the support body in the in-plane direction. In the first invention, since the actuator is supported via the first elastic member by the support body, it is possible to adopt a mode in which the vibration is transmitted to the operator via the support body of the actuator.

In the first invention, it is possible to adopt a mode in which each of the plurality of actuators includes, as the magnetic drive circuit, a first magnetic drive circuit configured to drive the movable body in a first direction of the in-plane direction relative to the support body, and a second magnetic drive circuit configured to drive the movable body in a second direction crossing the first direction in the in-plane direction relative to the support body.

In the first invention, it is possible to adopt a mode in which the plurality of actuators include a first actuator in which the magnetic drive circuit drives the movable body in a first direction of the in-plane direction relative to the support body, and a second actuator in which the magnetic drive circuit drives the movable body in a second direction crossing the first direction in the in-plane direction relative to the support body.

In the first invention, it is possible to adopt a mode in which the input member is provided to vibrate together with the touch panel, and the actuator transmits the vibration to at least one of the input member and the touch panel.

In the first invention, it is possible to adopt a mode in which the input member is provided to be spaced apart from the touch panel, and the actuator transmits the vibration only to the input member out of the input member and the touch panel. According to such a mode, it is not necessary to transmit the vibration to the touch panel itself, so that the input member can be vibrated efficiently.

In the first invention, it is possible to adopt a mode in which the input member is a light transmitting plate. In the present invention, it is possible to adopt a mode in which the input member is a light-transmitting sheet.

In the first invention, it is preferable to include a flexible sheet configured to cover a circumference of the input member. According to such a mode, invasion of foreign matters or the like into an interior of the device can be suppressed.

To solve the above problems, a touch panel-equipped display device according to a second invention is characterized by comprising: a display member; a light transmitting touch panel arranged to overlap the display member; a panel holder configured to support the display member; and an actuator configured to transmit vibration in an in-plane direction of an input surface to an input member configuring the input surface for the touch panel, the actuator not being connected to the panel holder, wherein the input member is supported by the panel holder via a first elastic member having at least one of elasticity and viscoelasticity.

In the second invention, the input member configuring the input surface for the touch panel is supported by the panel holder via the first elastic member, and the actuator transmits the vibration in the in-plane direction of the input surface to the input member. Therefore, the operator touching the input surface can be made to feel the vibration through the input member. Further, the actuator is not connected to the panel holder and transmits the vibration to the input member, and thus, even if the operator strongly presses the input surface, the actuator, which vibrates independently of the panel holder, can properly transmit the vibration to the operator.

In the second invention, it is preferable that the actuator and the first elastic member are provided to overlap the input member on the side where the display member is positioned with respect to the input member. According to such a mode, since the actuator and the first elastic member do not exist around the input member, it is easy to adopt a mode in which a peripheral area around the input member is narrowed and a mode in which another member is arranged, for example.

In the second invention, it is possible to adopt a mode in which a plurality of the actuators are provided. According to such a mode, it is possible to achieve a mode in which strong vibrations in the same direction are transmitted to the operator by the plurality of actuators, and a mode in which vibrations in different directions are transmitted to the operator by the plurality of actuators.

In the second invention, it is possible to adopt a mode in which when viewed from a direction orthogonal to the input surface, the plurality of actuators are arranged point-symmetrically about a center position of the input member or line-symmetrically about an imaginary line passing through the center position. According to such a mode, it is possible to transmit vibration with a sense of creativity to the operator.

In the second invention, it is possible to adopt a mode in which each of the plurality of actuators includes a support body configured to transmit vibration to the input member, a movable body, a second elastic member having at least one of elasticity and viscoelasticity, the second elastic member being connected to the support body and the movable body, and a magnetic drive circuit configured to drive the movable body relative to the support body in the in-plane direction. In the second invention, since the actuator is not connected to the panel holder and transmits the vibration to the input member, it is possible to adopt a mode in which the vibration is transmitted to the operator via the support body of the actuator.

In the second invention, it is possible to adopt a mode in which each of the plurality of actuators includes, as the magnetic drive circuit, a first magnetic drive circuit configured to drive the movable body in a first direction of the in-plane direction relative to the support body, and a second magnetic drive circuit configured to drive the movable body in a second direction crossing the first direction in the in-plane direction relative to the support body.

In the second invention, it is possible to adopt a mode in which the plurality of actuators include a first actuator in which the magnetic drive circuit drives the movable body in a first direction of the in-plane direction relative to the support body, and a second actuator in which the magnetic drive circuit drives the movable body in a second direction crossing the first direction in the in-plane direction relative to the support body.

In the second invention, it is possible to adopt a mode in which the input member is provided to vibrate together with the touch panel, and the actuator transmits the vibration to at least one of the input member and the touch panel.

In the second invention, it is possible to adopt a mode in which the input member is provided to be spaced apart from the touch panel, and the actuator transmits the vibration only to the input member out of the input member and the touch panel. According to such a mode, it is not necessary to transmit the vibration to the touch panel itself, so that the input member can be vibrated efficiently.

In the second invention, it is possible to adopt a mode where the panel holder includes a side plate portion around the display member, and the first elastic member is connected to the side plate portion.

In the second invention, it is possible to adopt a mode where the side plate portion includes a step portion recessed toward an opposite of the input member, and the first elastic member is connected to the step portion. According to such a mode, it is possible to reduce a thickness of the touch panel-equipped display device.

In the second invention, it is possible to adopt a mode where the first elastic member is arranged to fill a gap between the display member and the touch panel. According to such a mode, between the display member and the touch panel, there is no interface between the display member and an air space or between the touch panel and the air space. Therefore, between the display member and the touch panel, reflection at the interface of the display member or the touch panel can be suppressed.

In the second invention, it is possible to adopt a mode in which the input member is a light transmitting plate. In the present invention, it is possible to adopt a mode in which the input member is a light-transmitting sheet.

In the second invention, it is preferable that an entire circumference of the first elastic member is formed continuously. According to such a mode, invasion of foreign matters or the like into an interior of the device can be suppressed.

In the second invention, it is preferable to include a flexible sheet configured to cover a circumference of the input member. According to such a mode, invasion of foreign matters or the like into an interior of the device can be suppressed.

### Effect of the Invention

In the first invention, the actuator can transmit the vibration in the in-plane direction of the input surface to the input member configuring the input surface for the touch panel, and thus, it is possible for an operator touching the input surface to feel the vibration through the input member. Further, in the first invention, the actuator is supported via the first elastic member by the panel holder, and thus, even if the operator strongly presses the input surface, the actuator, which vibrates independently of the panel holder, can properly transmit the vibration to the operator.

In the second invention, the input member configuring the input surface for the touch panel is supported by the panel holder via the first elastic member, and the actuator transmits the vibration in the in-plane direction of the input surface to the input member. Therefore, the operator touching the input surface can be made to feel the vibration through the input member. Further, the actuator is not connected to the panel holder and transmits the vibration to the input member, and thus, even if the operator strongly presses the input surface, the actuator, which vibrates independently of the panel holder, can properly transmit the vibration to the operator.

### BRIEF DESCRIPTION OF THE DRAWINGS

FIG. 1 is an explanatory diagram illustrating an example of a planar configuration of a touch panel-equipped display device according to a first embodiment of a first invention.

FIG. 2 is a cross-sectional view of the touch panel-equipped display device illustrated in FIG. 1.

FIG. 3 is a perspective view illustrating an example of a configuration of an actuator used in the touch panel-equipped display device illustrated in FIG. 1.

FIG. 4 shows cross-sectional views of the actuator illustrated in FIG. 3.

FIG. 5 is an exploded perspective view of the actuator illustrated in FIG. 3.

FIG. 6 is an exploded perspective view of main parts of the actuator illustrated in FIG. 3.

FIG. 7 is an exploded perspective view of a state where some magnets, coils, and the like are removed from a movable body and a support body in the main parts of the actuator illustrated in FIG. 3.

FIG. 8 is a cross-sectional view of a touch panel-equipped display device according to a second embodiment of the first invention.

FIG. 9 is a cross-sectional view of a touch panel-equipped display device according to a third embodiment of the first invention.

FIG. 10 is a cross-sectional view of a touch panel-equipped display device according to a fourth embodiment of the first invention.

FIG. 11 is a cross-sectional view of a touch panel-equipped display device according to a fifth embodiment of the first invention.

FIG. 12 is a cross-sectional view of a touch panel-equipped display device according to a sixth embodiment of the first invention.

FIG. 13 is a cross-sectional view of a touch panel-equipped display device according to a seventh embodiment of the first invention.

FIG. 14 is a cross-sectional view of a touch panel-equipped display device according to an eighth embodiment of the first invention.

FIG. 15 is a cross-sectional view of a touch panel-equipped display device according to a ninth embodiment of the first invention.

FIG. 16 is an explanatory diagram illustrating a layout of an actuator 1 in a touch panel-equipped display device according to a tenth embodiment of the first invention.

FIG. 17 is an explanatory diagram of an actuator used in the touch panel-equipped display device according to an eleventh embodiment of the first invention.

FIG. 18 is an explanatory diagram of a touch panel-equipped display device according to a twelfth embodiment of the first invention.

FIG. 19 is an explanatory diagram illustrating an example of a planar configuration of a touch panel-equipped display device according to a first embodiment of a second invention.

FIG. 20 is a cross-sectional view of the touch panel-equipped display device illustrated in FIG. 19.

FIG. 21 is a cross-sectional view of a touch panel-equipped display device according to a second embodiment of the second invention.

FIG. 22 is a cross-sectional view of a touch panel-equipped display device according to a third embodiment of the second invention.

FIG. 23 is a cross-sectional view of a touch panel-equipped display device according to a fourth embodiment of the second invention.

FIG. 24 is a cross-sectional view of a touch panel-equipped display device according to a fifth embodiment of the second invention.

FIG. 25 is an explanatory diagram illustrating a layout of the actuator 1 in a touch panel-equipped display device according to a sixth embodiment of the second invention.

FIG. 26 is an explanatory view of an actuator used in a touch panel-equipped display device according to a seventh embodiment of the second invention.

FIG. 27 is an explanatory diagram of a touch panel-equipped display device according to an eighth embodiment of the second invention.

### DESCRIPTION OF THE EMBODIMENTS

Below, an embodiment of the present invention will be described with reference to the drawings.

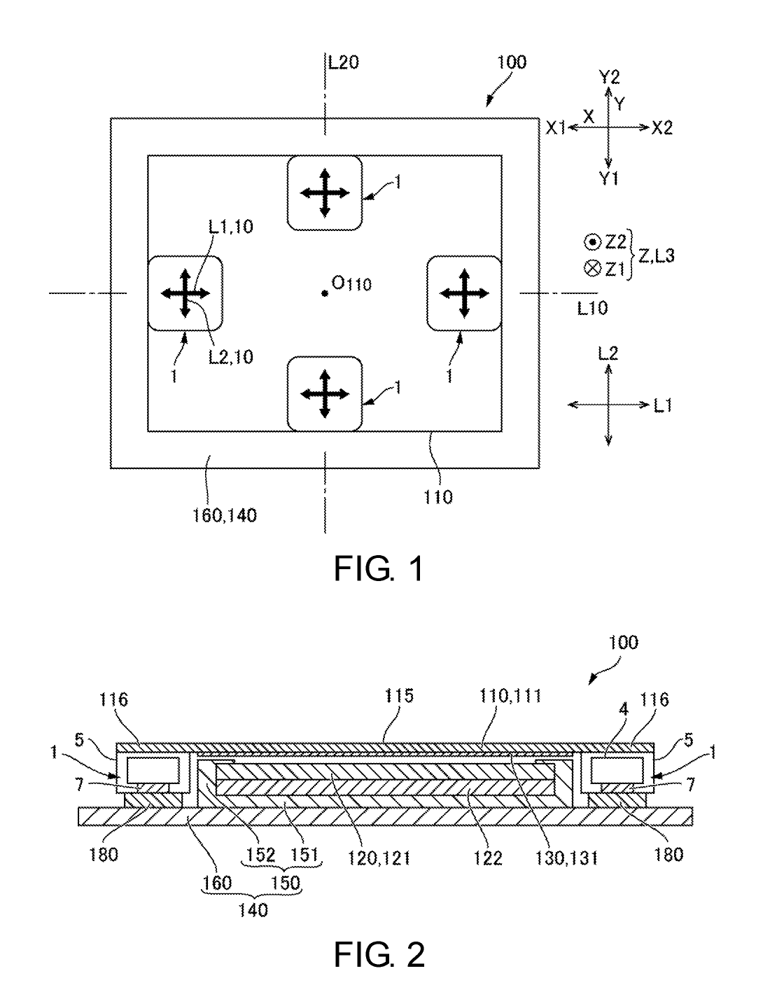

Embodiments of a first invention will be described with reference to FIG. 1 to FIG. 18. It is noted that in the following description, for a purpose of clarifying a layout and the like of a touch panel-equipped display device 100 and an actuator 1, description proceeds where mutually crossing directions are defined as an X-axis direction, a Y-axis direction, and a Z-axis direction, where one side in the X-axis direction is X1, the other side in the X-axis direction is X2, one side in the Y-axis direction is Y1, the other side in the Y-axis direction is Y2, one side in the Z-axis direction is Z1, and the other side in the Z-axis direction is Z2. In addition, the X-axis direction and the Y-axis direction are directions along an input surface for a touch panel, and the Z-axis direction is a normal direction to the input surface.

### First Embodiment

### (Configuration of Touch Panel-Equipped Display Device 100)

FIG. 1 is an explanatory diagram illustrating an example of a planar configuration of the touch panel-equipped display device 100 according to a first embodiment of the first invention. FIG. 2 is a cross-sectional view of the touch panel-equipped display device 100 illustrated in FIG. 1. In addition, in FIG. 1, the directions of vibrations generated by each actuator 1 are indicated by thick arrows. The touch panel-equipped display device 100 illustrated in FIG. 1 and FIG. 2 includes a display member 120, a light transmitting touch panel 130 arranged to overlap on the other side Z2 in the Z-axis direction relative to the display member 120, and a panel holder 140 configured to support the display member 120. In the preset embodiment, the display member 120 is a liquid crystal panel 121, and a backlight device 122 is arranged on the opposite side of the touch panel 130 relative to the liquid crystal panel 121. The panel holder 140 includes a first holder 150 configured to house therein the liquid crystal panel 121 and the backlight device 122, and a second holder 160 configured to support the first holder 150 on the opposite side of the display member 120 (on the one side Z1 in the Z-axis direction). The first holder 150 includes a bottom plate 151 configured to support the liquid crystal panel 121 and the backlight device 122 on the one side Z1 in the Z-axis direction, and a side plate portion 152 configured to surround the liquid crystal panel 121 and the backlight device 122. The second holder 160 has a plate shape.

The touch panel-equipped display device 100 includes a light transmitting input member 110 configuring an input surface 115 for the touch panel 130, and an actuator 1 configured to transmit, to the input member 110, vibration in an in-plane direction of the input surface 115. Further, the touch panel-equipped display device 100 includes a first elastic member 180 connected to the actuator 1 and the panel holder 140, and the actuator 1 is supported by the second holder 160 of the panel holder 140 via the first elastic member 180. Here, the input member 110 and the touch panel 130 do not contact the panel holder 140.

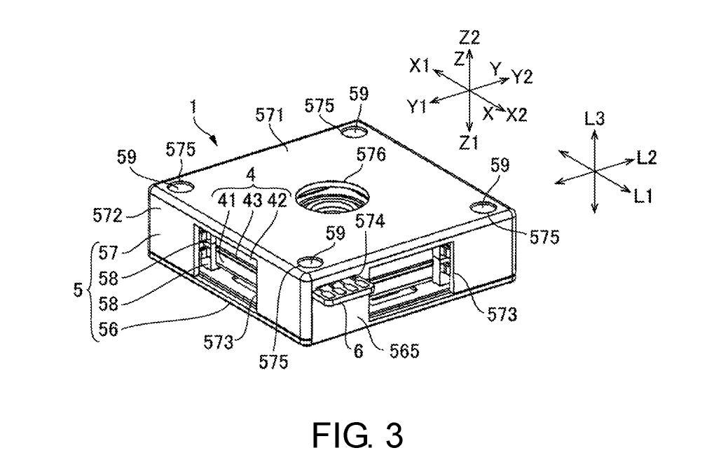

In the present embodiment, as described with reference to FIG. 3 to FIG. 7, the actuator 1 includes a support body 5 configured to transmit vibration to the input member 110, a movable body 4, a second elastic member 7 connected to the support body 5 and the movable body 4, and a magnetic drive circuit (not illustrated) configured to drive the movable body 4 relative to the support body 5, and the movable body 4 is supported by the support body 5 via the second elastic member 7. The actuator 1 generates vibrations in two mutually orthogonal directions (a first direction L1 and a second direction L2), as described later. In the present embodiment, the drawings are so prepared that the first direction L1 is a direction along the X-axis direction and the second direction L2 is a direction along the Y-axis direction.

In the present embodiment, the first elastic member 180 has at least one of elasticity and viscoelasticity, and the first elastic member 180 is arranged between the actuator 1 and the second holder 160. The number of the actuator 1 is plural, and the first elastic member 180 is arranged between each of the plurality of actuators 1 and the second holder 160. In the present embodiment, the first elastic member 180 is made of a viscoelastic body. Examples of the viscoelastic body to be employed may include various types of rubber materials and a modified material thereof including natural rubber, diene-based rubber (such as styrene-butadiene rubber, isoprene rubber, butadiene rubber, chloroprene rubber and acrylonitrile-butadiene rubber), non-diene rubber (such as butyl rubber, ethylene-propylene rubber, ethylene-propylene-diene rubber, urethane rubber, silicone rubber, and fluororubber), and a thermoplastic elastomer. Further, as the viscoelastic body, gel such as silicone gel can be used.

The touch panel 130 is a capacitive type touch panel 131, and the input member 110 is formed of a light transmitting plate 111. Further, the touch panel 130 and the input member 110 (light transmitting plate 111) are fixed with an adhesive or the like. The input member 110 has a larger size than the touch panel 130 and has an overhang unit 116 overhang from the touch panel 130 in the in-plane direction along the input surface 115. In the present embodiment, the actuator 1 is connected to the overhang unit 116 overhanging from the touch panel 130 and is not connected to the touch panel 130. Further, the actuator 1 is connected to a rear surface side (one side Z1 in the Z-axis direction) where the display member 120 is positioned with respect to the overhang unit 116, and when viewed from the Z-axis direction, the actuator 1 and the first elastic member 180 overlap with the overhang unit 116. Therefore, when viewed from the Z-axis direction, the actuator 1 and the first elastic member 180 do not overhand outward from the input member 110.

In the thus-configured touch panel-equipped display device 100, each of the plurality of actuators 1 transmits the vibration in the first direction L1 along the X-axis direction and the vibration in the second direction L2 along the Y-axis direction, to the input member 110. In the present embodiment, when viewed from the third direction L3 along the Z-axis direction, the plurality of actuators 1 are arranged around a center position O110 of the input member 110. A planar shape of the input member 110 is a quadrangle. More specifically, the planar shape of the input member 110 is an oblong rectangle, and a total of four actuators 1 are arranged near a center of four sides of the input member 110. Therefore, when viewed from the Z-axis direction, the plurality of actuators 1 are arranged point-symmetrically about the center position O110 of the input member 110. Further, the plurality of actuators 1 are arranged line-symmetrically about a first imaginary line L10 extending in the X-axis direction and passing through the center position O110 of the input member 110, and are arranged line-symmetrically about a second imaginary line L20 extending in the Y-axis direction and passing through the center position O110 of the input member 110.

### (Operation in Touch Panel-Equipped Display Device 100)

In the thus-configured touch panel-equipped display device 100, if a predetermined position on the input surface 115 is touched with a fingertip, a controller (not illustrated) drives the plurality of actuators 1. Therefore, the vibration output from the actuators 1 is transmitted to the input member 110. Therefore, it is possible to transmit the vibration to the fingertip of an operator. At that time, if the vibration in the X-axis direction is generated in any of the plurality of actuators 1, the operator feels the vibration in the X-axis direction. Further, if the vibration in the Y-axis direction is generated in any of the plurality of actuators 1, the operator feels the vibration in the Y-axis direction. At this time, for example, in the vibration in the Y-axis direction, if the acceleration of vibration is differed between when the fingertip moves to the one side Y1 of the Y-axis and when the fingertip moves to the other side Y2 thereof, the operator will feel vibration having directionality in the Y-axis direction. Further, from among the plurality of actuators 1, the actuator 1 positioned on the opposite side across the center position O110 may generate vibration having directionality in the opposite direction around the center position O110. In this case, the operator will feel the vibration having directionality toward one side around the center position O110 from the input member 110.

### (Example of Specific Configuration of Actuator 1)

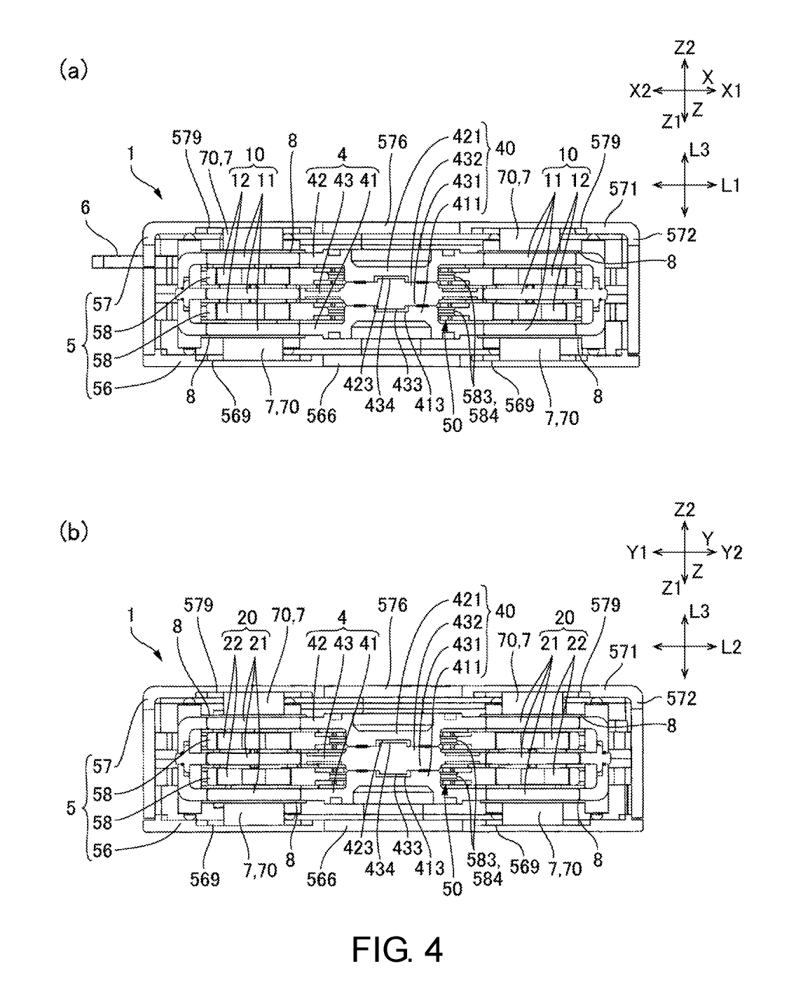

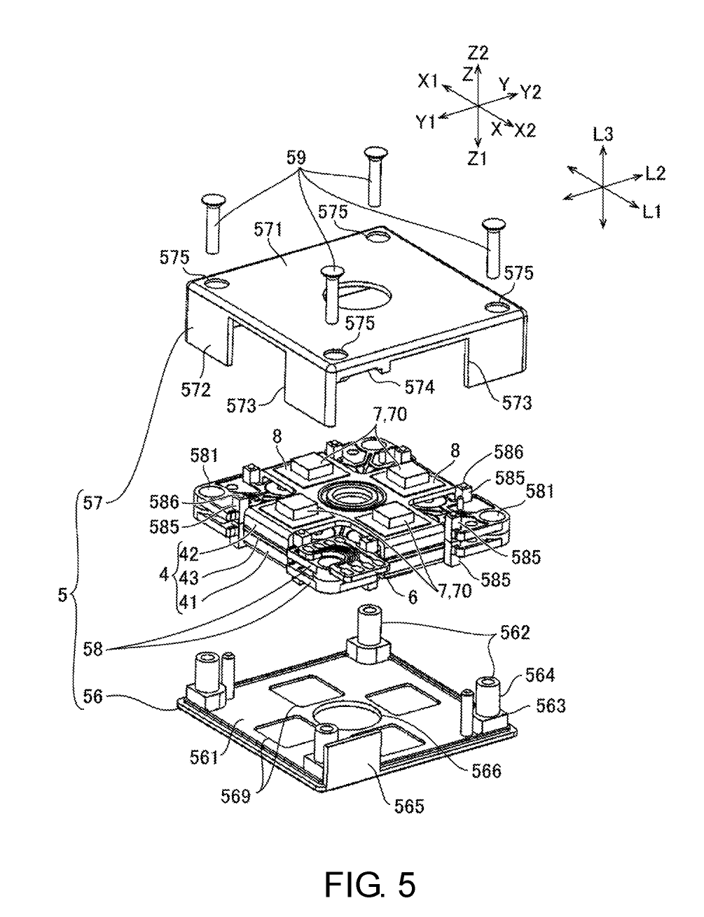

FIG. 3 is a perspective view illustrating an example of a configuration of the actuator 1 used in the touch panel-equipped display device 100 illustrated in FIG. 1. FIG. 4 shows cross-sectional views of the actuator 1 illustrated in FIG. 3, and FIG. 4(a) is an X-Z cross-sectional view when the actuator 1 is cut along a line passing through a center portion of the actuator 1, and FIG. 4(b) is a Y-Z cross-sectional view when the actuator 1 is cut along a line passing through the central portion of the actuator 1, respectively. FIG. 5 is an exploded perspective view of the actuator 1 illustrated in FIG. 3. It is noted that the actuator 1 described below generates vibrations in two mutually orthogonal directions (the first direction L1 and the second direction L2), and in the following description, illustration is prepared so that the first direction L1 is a direction along the X-axis direction and the second direction L2 is a direction along the Y-axis direction. Further, in the actuator 1, the third direction L3 is a direction along the Z-axis direction.

In FIG. 3, FIG. 4, and FIG. 5, in the actuator 1, the first magnetic drive circuit 10 includes a first coil 12 held by the support body 5 and a first magnet 71 held by the movable body 4, and the first magnet 11 and the first coil 12 face each other in the Z-axis direction (third direction L3). A second magnetic drive circuit 20 includes a second coil 22 held by the support body 5 and a second magnet 21 held by the movable body 4, and the second magnet 21 and the second coil 22 face each other in the Z-axis direction (third direction L3). The first magnetic drive circuit 10 generates a driving force in the first direction L1 and the second magnetic drive circuit 20 generates a driving force in the second direction L2. Here, the first magnet 11 and the first coil 12 are arranged at two positions spaced apart in the first direction L1. That is, the first magnetic drive circuit 10 is arranged at two positions spaced apart in the first direction L1. In addition, the second magnet 21 and the second coil 22 are arranged at two positions spaced apart in the second direction L2. That is, the second magnetic drive circuit 20 is arranged at two positions spaced apart in the second direction L2.

### (Configuration of Support Body 5)

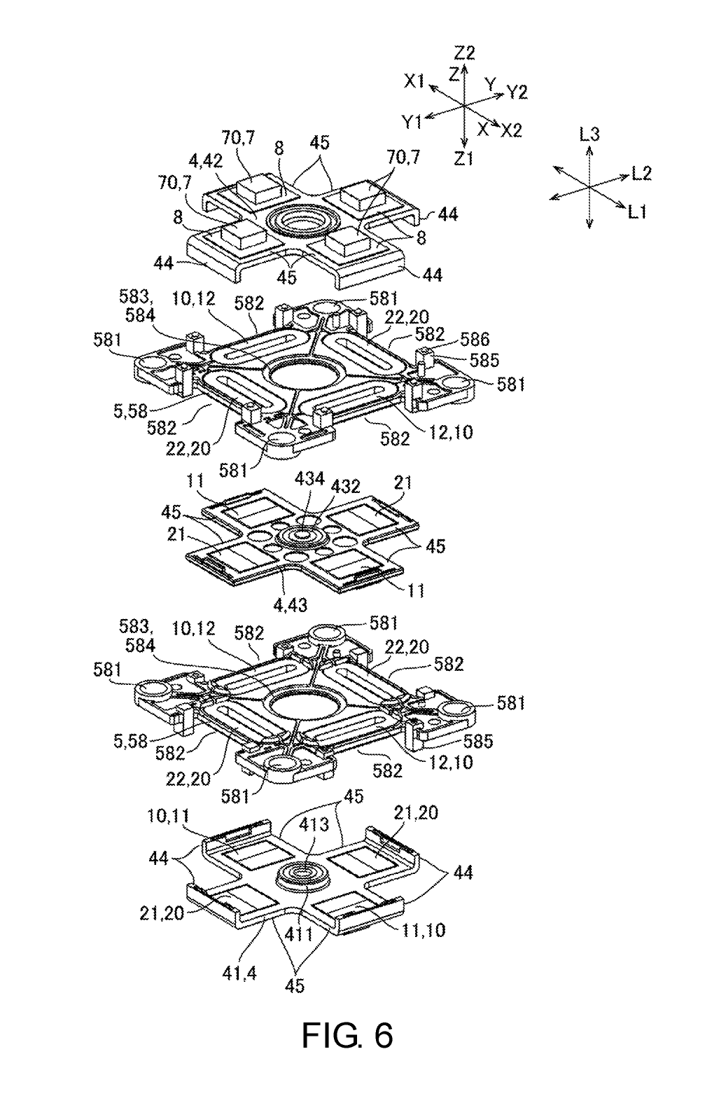

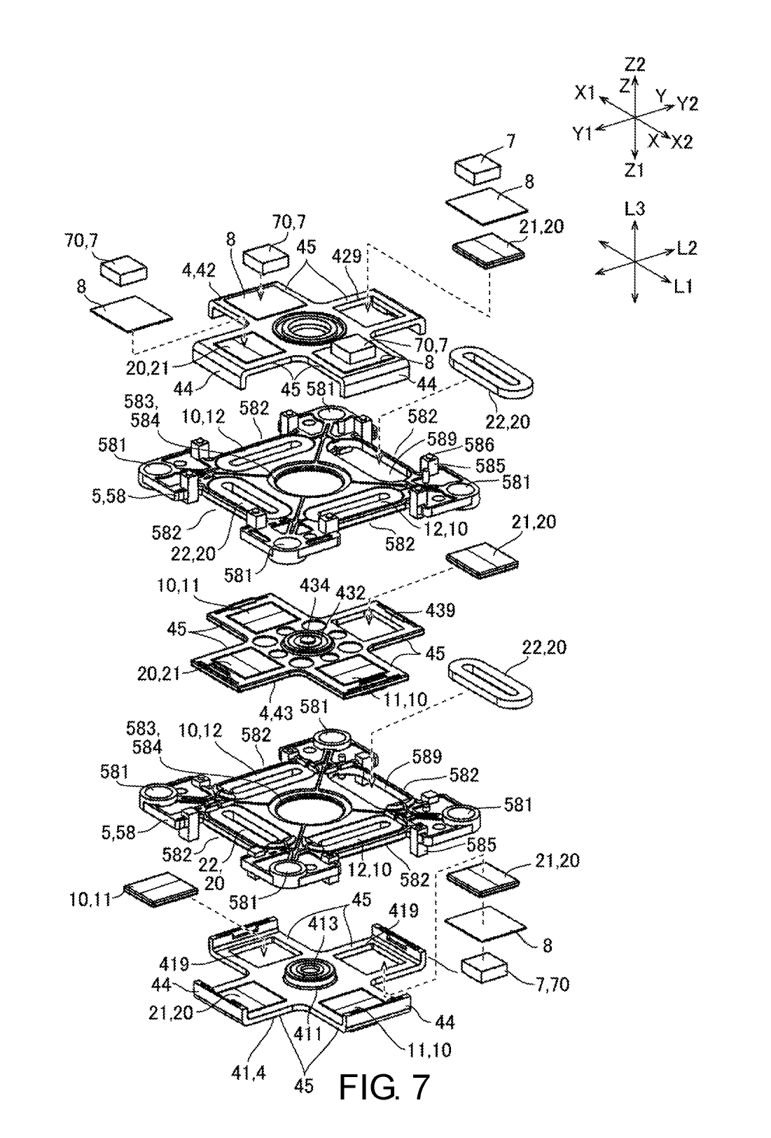

FIG. 6 is an exploded perspective view of main parts of the actuator 1 illustrated in FIG. 3. FIG. 7 is an exploded perspective view of a state where some magnets, coils, and the like are removed from the movable body 4 and the support body 5 in the main parts of the actuator 1 illustrated in FIG. 3.

The support body 5 includes a first case 56 positioned on the one side Z1 in the Z-axis direction, a second case 57 covering the first case 56 on the other side Z2 in the Z-axis direction, and a holder 58 (support body side holder) arranged between the first case 56 and the second case 57, and the first case 56 and the second case 57 are fixed by four fixing screws 59 with the holder 58 interposed therebetween.

The second case 57 includes an end plate 571 having a quadrangular planar shape when viewed from the Z-axis direction, and four side plate portions 572 projecting from the respective edges of the end plate 571 toward the side of the first case 56. In the end plate 571, a circular hole 576 is formed at a center, and fixing holes 575 are formed at four corners. A cutout portion 573 cut out from the one side Z1 to the other side Z2 in the Z-axis direction is formed in a central portion of the four side plate portions 572. In the side plate portion 572 on the other side L2 in the first direction L1, a cutout portion 574 is formed which is obtained by cutting out a portion adjacent to the cutout portion 573 by a part of a height in the Z-axis direction. It is noted that in a second invention described later, in the side plate portion 572 on the other side Y2 in the Y-axis direction Y, a cutout portion 574 is formed which is obtained by cutting out a portion adjacent to the cutout portion 573 by a part of a height in the Z-axis direction.

The first case 56 includes an end plate 561 having a quadrangular planar shape when viewed from the Z-axis direction, and a boss 562 protruding from each of four corners of the end plate 561 toward the end plate 571 of the second case 57. A circular hole 566 is formed in a center of the end plate 561. The boss 562 includes a step surface 563 formed somewhere in the Z-axis direction and a cylinder 564 projecting from the step surface 563 toward the other side Z2 in the Z-axis direction. Therefore, when the fixing screws 59 are screwed from the fixing hole 575 of the second case 57 into the boss 562 of the first case 56 from the other side Z2 in the Z-axis direction, the end plate 571 of the first case 56 is fixed to an end on the one side Z1 in the Z-axis direction of the side plate portion 572. The first case 56 is provided with a rising portion 565 facing, in the first direction L1, the cutout portion 574 of the second case 57, and the rising portion 565 configures a slit configured to arrange a substrate 6 between the rising portion 565 and the cutout portion 574. A power supply line to the first coil 12 and the second coil 22 and the like are connected to the substrate 6.

As illustrated in FIG. 4, FIG. 6, and FIG. 7, between the first case 56 and the second case 57, two holders 58 are arranged to overlap each other in the Z-axis direction. A basic structure of the two holders 58 is common, and a hole 583 is formed in a center thereof. In the present embodiment, the hole 583 is circular. Circular holes 581 are formed at four corners of the two holders 58, and the holders 58 are held in a state where the cylinder 564 of the boss 562 is inserted into the circular hole 581 and is positioned by the step surface 563. At a center of the four sides of the holder 58, a concave portion 582 recessed toward an inner peripheral side is formed.

Here, the two holders 58 are formed by inverting a plate-like member having the same configuration about the Z-axis direction. Therefore, from among the two holders 58, a column-like protrusion 585 protrudes from the holder 58 arranged on the one side Z1 in the Z-axis direction toward the first case 56, and a plurality of column-like protrusions 585 protrude from the holder 58 arranged on the other side Z2 in the Z-axis direction toward the second case 57. Further, in any one of the plurality of column-like protrusions 585, a spherical abutting portion 586 is formed at a distal end. Therefore, when the first case 56 and the second case 57 are fixed by the fixing screw 59 with the holder 58 interposed therebetween, the first case 56, the two holders 58, and the second case 57 are surely positioned in the Z-axis direction.

### (Arrangement of First Coil 12 and Second Coil 22)

In the two holders 58, elongated hole-shaped through holes 589 are formed at four locations between the concave portion 582 and the hole 583. In each of the two holders 58, the first coil 12 of the first magnetic drive circuit 10 is held inside the two through holes 589 spaced apart each other in the second direction L2, from among the four through holes 589. Further, in each of the two holders 58, the second coil 22 of the second magnetic drive circuit 20 is held inside the two through holes 589 spaced apart in the third direction L3. Therefore, each of the two holders 58 holds the first coil 12 and the second coil 22 for one stage in the Z-axis direction, and the first coil 12 and the second coil 22 are arranged on the side of the support body 5 in two stages overlapping in the Z-axis direction. The first coil 12 is a flat air-core coil whose long side or effective side extends in the second direction L2, and the second coil 22 is a flat air-core coil whose long side or effective side extends in the first direction L1.

### (Configuration of Movable Body 4)

The movable body 4 includes a plate-like first holder 41 (movable body side holder) located on the one side Z1 in the Z-axis direction with respect to the two holders 58, a second holder 42 (movable body side holder) located on the other side Z2 in the Z-axis direction with respect to the two holders 58, and a plate-like third holder 43 (movable body side holder) arranged between the two holders 58. The first holder 41, the second holder 42, and the third holder 43 each include four protrusions 45 protruding on both sides in the first direction L1 and the second direction L2, and have a +(plus) shape, when viewed from the Z-axis direction. A distal end of each of the protrusions 45 formed in the first holder 41 is a joint 44 bent to the other side Z2 in the Z-axis direction, and a distal end of each of the protrusions 45 formed in the second holder 42 is a joint 44 bent to the one side Z1 in the Z-axis direction. Therefore, when the first holder 41, the second holder 42, and the third holder 43 are stacked, the distal ends of the protrusions 45 of the first holder 41, the second holder 42, and the third holder 43 each contact. Therefore, when the distal ends of the protrusions 45 of the first holder 41, the second holder 42, and the third holder 43 are each joined by a method such as adhering and welding, a state is achieved where the first holder 41, the second holder 42, and the third holder 43 are integrally connected.

### (Arrangement of First Magnet 11 and Second Magnet 21)

In the first holder 41, the second holder 42, and the third holder 43, rectangular through holes 419, 429, 439 are formed in the respective four protrusions 45 protruding on both sides in the first direction L1 and the second direction L2. The first magnets 11 of the first magnetic drive circuit 10, from among the four protrusions 45, are held in the through holes 419, 429, 439 of the two protrusions 45 spaced apart in the first direction L1. Further, the second magnets 21 of the second magnetic drive circuit 20 are held in the through holes 419, 429, 439 of the two protrusions 45 spaced apart in the second direction L2. Therefore, each of the first holder 41, the second holder 42, and the third holder 43 holds the first magnet 11 and the second magnet 21 for one stage in the Z-axis direction.

In this way, in the first magnetic drive circuit 10, a plurality of first coils 12 are arranged in multiple stages to overlap in the Z-axis direction, and the first magnets 11 are arranged on both sides of each of the plurality of first coils 12 in the Z-axis direction. In addition, in the second magnetic drive circuit 20, a plurality of second coils 22 are arranged in multiple stages to overlap in the Z-axis direction, and the second magnets 21 are arranged on both sides of each of the plurality of second coils 22 in the Z-axis direction. In the present embodiment, the first coils 12 and the second coils 22 are arranged in two stages to overlap in the Z-axis direction, and on both sides in the Z-axis direction of each of the two-staged first coils 12 and second coils 22, the first magnets 11 and the second magnets 21 are arranged. The first magnets 11 are plate-like magnets whose magnetized polarization line extends in the second direction L2, and the second magnets 21 are plate-like magnets whose magnetized polarization line extends in the first direction L1.

Here, a back yoke 8 is arranged to overlap on the one side Z1 in the Z-axis direction with respect to the first magnet 11 and the second magnet 21 held by the first holder 41. Further, the back yoke 8 is arranged to overlap on the other side Z2 in the Z-axis direction with respect to the first magnets 11 and the second magnets 21 held by the second holder 42. The back yoke 8 is larger in size than the first magnets 11 and the second magnets 21 (than the through holes 419 and 429), and is fixed to the first holder 41 and the second holder 42 by a method such as adhesive.

### (Configuration of Second Elastic Member 7)

Between the back yoke 8 provided in the first holder 41 and the end plate 561 of the first case 56, second elastic members 7 contacting the back yoke 8 and the first case 56 are provided at four locations. Further, between the back yoke 8 provided in the second holder 42 and the end plate 571 of the second case 57, second elastic members 7 contacting the back yoke 8 and the second case 57 are provided at four positions.

In the present embodiment, the second elastic members 7 have at least one of elasticity and viscoelasticity. In the present embodiment, the second elastic members 7 are made of a viscoelastic body. Further, examples of the viscoelastic body to be employed may include various types of rubber materials and a modified material thereof including natural rubber, diene-based rubber (such as styrene-butadiene rubber, isoprene rubber butadiene rubber, chloroprene rubber and acrylonitrile-butadiene rubber), non-diene rubber (such as butyl rubber, ethylene-propylene rubber, ethylene-propylene-diene rubber, urethane rubber, silicone rubber, and fluororubber), and a thermoplastic elastomer. Further, as the viscoelastic body, gel such as silicone gel can be used. In the present embodiment, the second elastic members 7 are formed of a gel-like damper member 70 provided between the movable body 4 and the support body 5. In the present embodiment, the gel-like damper member 70 is made of a plate-like silicone gel. A planar shape of the gel-like damper member 70 is a polygon such as a rectangle, and positions where the gel-like damper member 70 is arranged in the end plate 561 of the first case 56 and the end plate 571 of the second case 57 have concave portions 569 and 579 (see FIG. 4).

The gel-like damper member 70 has viscoelasticity and has linear or nonlinear stretch characteristics depending on a direction of expansion and contraction. For example, if the plate-like gel-like damper member 70 is compressed and deformed by being pressed in a thickness direction (axial direction), the plate-like gel-like damper member 70 has a stretch characteristic where a nonlinear component is larger than a linear component. On the other hand, when pulled and stretched in the thickness direction (axial direction), the plate-like gel-like damper member 70 has a stretch characteristic where the linear component is larger than the nonlinear component. Further, when deforming in a direction (shearing direction) crossing the thickness direction (axial direction), the plate-like gel-like damper member 70 has a deformation characteristic where the linear component is larger than the nonlinear component. In the present embodiment, the gel-like damper member 70 is made of a quadrangular prism-shaped silicone gel.

### (Configuration of Stopper Mechanism 50)

As illustrated in FIG. 4 and the like, in a central portion of the first holder 41, a convex connection part 411 smaller in outer diameter than the hole 583 of the holder 58 protrudes toward the other side Z2 in the Z-axis direction, and in a central portion of the second holder 42, a convex connection part 421 smaller in outer diameter than the hole 583 of the holder 58 protrudes toward the one side Z1 in the Z-axis direction. In a central portion of the third holder 43, a convex connection part 431 smaller in outer diameter than the hole 583 of the holder 58 protrudes toward the one side Z1 in the Z-axis direction, and a convex connection part 432 smaller in outer diameter than the hole 583 of the holder 58 protrudes toward the other side Z2 in the Z-axis direction. The convex connection part 431 of the third holder 43 abuts against the convex connection part 411 of the first holder 41 inside the hole 583 of the holder 58. The convex connection part 432 of the third holder 43 abuts against the convex connection part 421 of the second holder 42 inside the hole 583 of the holder 58. Distal ends of the convex connection parts 431 and 432 of the third holder 43 are formed with positioning convex portions 433 and 434, and distal ends of the convex connection parts 411 and 421 of the first holder 41 and the second holder 42 are formed with convex portions 413 and 423 into which the convex portions 433 and 434 are fitted. Further, the convex connection part 431 of the third holder 43 is joined to the convex connection part 411 of the first holder 41 with an adhesive or the like, and the convex connection part 432 of the third holder 43 is joined to the convex connection part 421 of the second holder 42 with an adhesive or the like. Therefore, inside the hole 583 of the holder 58, the first holder 41, the second holder 42, and the third holder 43 are connected by a trunk 40 formed of the convex connection parts 411, 431, 432, and 421.

As a result, the wall 584 inside of the hole 583 of the holder 58 provided in the support body 5 configures a stopper mechanism 50 configured to surround a circumferential surface of the trunk 40 provided in the movable body 4 to restrict a range where the movable body 4 can move in a direction orthogonal to the Z-axis direction.

### (Operation or the Like in Actuator 1)

In the actuator 1 of the present embodiment, if an alternating current is applied to the first coil 12 of the first magnetic drive circuit 10, the movable body 4 can be vibrated in the first direction L1. Further, when an alternating current is applied to the second coil 22 of the second magnetic drive circuit 20, the movable body 4 can be vibrated in the second direction L2. At that time, since a center of gravity of the actuator 1 varies in the first direction L1 and the second direction L2, the input member 110 described with reference to FIG. 1 vibrates in the first direction L1 and the second direction L2. Therefore, the operator can experience the vibration in the first direction L1 and the vibration in the second direction L2. At that time, if an alternating current waveform applied to the first coil 12 is adjusted to provide a difference between a speed at which the movable body 4 moves to the one side in the first direction L1 and a speed at which the movable body 4 moves to the other side in the first direction L1, the operator can experience a vibration having directionality in the first direction L1. Likewise, if an alternating current waveform applied to the second coil 22 is adjusted to provide a difference between a speed at which the movable body 4 moves to the one side in the second direction L2 and a speed at which the movable body 4 moves to the other side in the second direction L2, the operator can experience a vibration having directionality in the second direction L2.

Here, in the first magnetic drive circuit 10 and the second magnetic drive circuit 20, the first coil 12 and the first magnet 11 face each other in the Z-axis direction (third direction L3), and the second coil 22 and the second magnet 21 face each other in the Z-axis direction. Therefore, even in a case where the first magnetic drive circuit 10 and the second magnetic drive circuit 20 are provided, a size of the actuator 1 in the Z-axis direction can be relatively reduced. Therefore, in the first magnetic drive circuit 10 and the second magnetic drive circuit 20, the first coils 12 and the second coils 22 can be arranged in two stages to overlap in the Z-axis direction, and on both sides in the Z-axis direction of each of the two-staged first coils 12 and second coils 22, the first magnets 11 and the second magnets 21 can be arranged to increase the power of the first magnetic drive circuit 10 and the second magnetic drive circuit 20, and even in this case, the size of the actuator 1 in the Z-axis direction can be relatively reduced. Further, since the first magnet 11 and the second magnet 21 are arranged on the both sides of each of the two-staged first coil 12 and second coil 22 in the Z-axis direction, magnetic flux leakage is small as compared to a case where the magnets face only one side of the coil. Therefore, it is possible to increase a thrust for moving the movable body 4.

In addition, the first magnetic drive circuits 10 are provided at two positions spaced apart in the first direction L1 and overlapping when viewed from the Z-axis direction. Further, the second magnetic drive circuits 20 are provided at two positions spaced apart in the second direction L2 and overlapping when viewed from the Z-axis direction. Therefore, when the first magnetic drive circuit 10 and the second magnetic drive circuit 20 are driven to vibrate the movable body 4 in the first direction L1 and the second direction L2, the movable body 4 can be efficiently vibrated because the movable body 4 cannot easily rotate about the axis extending in the Z-axis direction.

Further, in the present embodiment, a gap between the first magnetic drive circuits 10 spaced apart in the first direction L1 and a gap between the second magnetic drive circuits 20 spaced apart in the second direction L2 are utilized to provide the stopper mechanism 50 configured to restrict a range where the movable body 4 can move in a direction orthogonal to the Z-axis direction. Therefore, when the movable body 4 vibrates in the first direction L1 and the second direction L2, the second elastic member 7 (gel-like damper member 70) will be deformed in a shearing direction, but the range where the movable body 4 can move can be set equal to or less than a critical deformation amount in the shearing direction of the gel-like damper member 70. Therefore, even if the movable body 4 vibrates to the utmost, the gel-like damper member 70 will not extend beyond the critical deformation amount, so that it is possible to avoid destruction of the gel-like damper member 70. In addition, since the gap between the first magnetic drive circuits 10 spaced apart in the first direction L1 and the gap between the second magnetic drive circuits 20 spaced apart in the second direction L2 are utilized to provide the stopper mechanism 50, it is possible to avoid the size of the actuator 1 from increasing even if the stopper mechanism 50 is arranged.

Further, in the actuator 1, if the second elastic member 7 connected to the movable body 4 and the support body 5 is a spring member, the movable body 4 may resonate at a frequency corresponding to a mass of the movable body 4 and a spring constant of the spring member, but in the present embodiment, the gel-like damper member 70 is used for the second elastic member 7. Further, in the present embodiment, only the gel-like damper member 70 is used for the second elastic member 7, and depending on the deformation direction of the gel-like damper member 70, the gel-like damper member 70 has a deformation characteristic where there is no or little spring component. Therefore, a resonance of the movable body 4 can be suppressed. In addition, the gel-like damper member 70 is fixed to both the movable body 4 and the support body 5 by a method such as adhesion. Therefore, it is possible to prevent the gel-like damper member 70 from moving with the movement of the movable body 4. Thus, since only the gel-like damper member 70 can be used as the second elastic member 7, a configuration of the actuator 1 can be simplified. Further, the gel-like damper member 70 has a penetration degree of 90 degrees to 110 degrees. Therefore, the gel-like damper member 70 has sufficient elasticity to exhibit a damper function, and hardly invites a situation where the gel-like damper member 70 breaks and scatters.

Further, if the movable body 4 moves in the first direction L1 and the second direction L2, the gel-like damper member 70 is deformed in a direction (shearing direction) perpendicular to a thickness direction (axial direction). Therefore, in the actuator 1, when the movable body 4 is vibrated in the first direction L1 and the second direction L2, the deformation characteristic in the shear direction of the gel-like damper member 70 is used. Here, there is more linear component than the nonlinear component in the deformation characteristic in the shear direction of the gel-like damper member 70. Therefore, in the drive direction of the actuator 1 (the first direction L1 and the second direction L2), it is possible to obtain a vibration characteristic with good linearity.

### Main Effect of Present Embodiment

As described above, in the touch panel-equipped display device 100 of the present embodiment, the actuator 1 can transmit the vibration in the in-plane direction of the input surface 115 to the input member 110 configuring the input surface 115 for the touch panel 130, and thus, it is possible for an operator touching the input surface 115 to feel the vibration through the input member 110. Further, in the present embodiment, since the actuator 1 is supported by the panel holder 140 via the first elastic member 180, even if the operator strongly presses the input surface 115, the actuator 1 vibrates independently of the panel holder 140. Therefore, it is possible to properly transmit the vibration to the operator.

Further, the actuator 1 and the first elastic member 180 are provided to overlap with the input member 110 on the side where the display member 120 is positioned with respect to the input member 110. Therefore, since the actuator 1 and the first elastic member 180 do not exist around the input member 110, it is easy to adopt a mode in which a peripheral region around the input member 110 is narrowed, a mode in which another member is arranged, or the like.

Further, there are a plurality of actuators 1, and thus, it is possible to achieve a mode in which strong vibrations in the same direction are transmitted to the operator by the plurality of actuators 1, and a mode in which vibrations in different directions are transmitted to the operator by the plurality of actuators 1. In addition, since the plurality of actuators 1 are arranged around the center position O110 of the input member 110 when viewed from the third direction L3 (the Z-axis direction), the vibration generated by the plurality of actuators 1 can be effectively transmitted to the common input member 110, and when different vibrations are generated by the plurality of actuators 1, the common input member 110 can be made to vibrate with a sense of creativity. Particularly, in the present embodiment, when viewed from the Z-axis direction orthogonal to the input surface 115, the plurality of actuators 1 are arranged point-symmetrically about the center position O110 of the input member 110 or line-symmetrically about the imaginary line passing through the center position O110. Therefore, the vibrations generated by the plurality of actuators 1 can be efficiently transmitted to the common input member 110, and when the different vibrations are generated by the plurality of actuators 1, the common input member 110 can be made to vibrate with a sense of creativity.

Further, in the actuator 1, since the movable body 4 is supported by the support body 5 via the second elastic member 7, the vibration can be transmitted to the operator via the support body 5 of the actuator 1. Even in that case, since the actuator 1 is supported by the panel holder 140 via the first elastic member 180, the vibration can be transmitted to the operator via the support body 5.

Further, each of the plurality of actuators 1 includes the first magnetic drive circuit 10 configured to vibrate the movable body 4 in the first direction L1 and the second magnetic drive circuit 20 configured to vibrate the movable body 4 in the second direction L2. Therefore, when the different vibrations are generated by the plurality of actuators 1, the common input member 110 can be made to vibrate with a sense of creativity.

### Second Embodiment

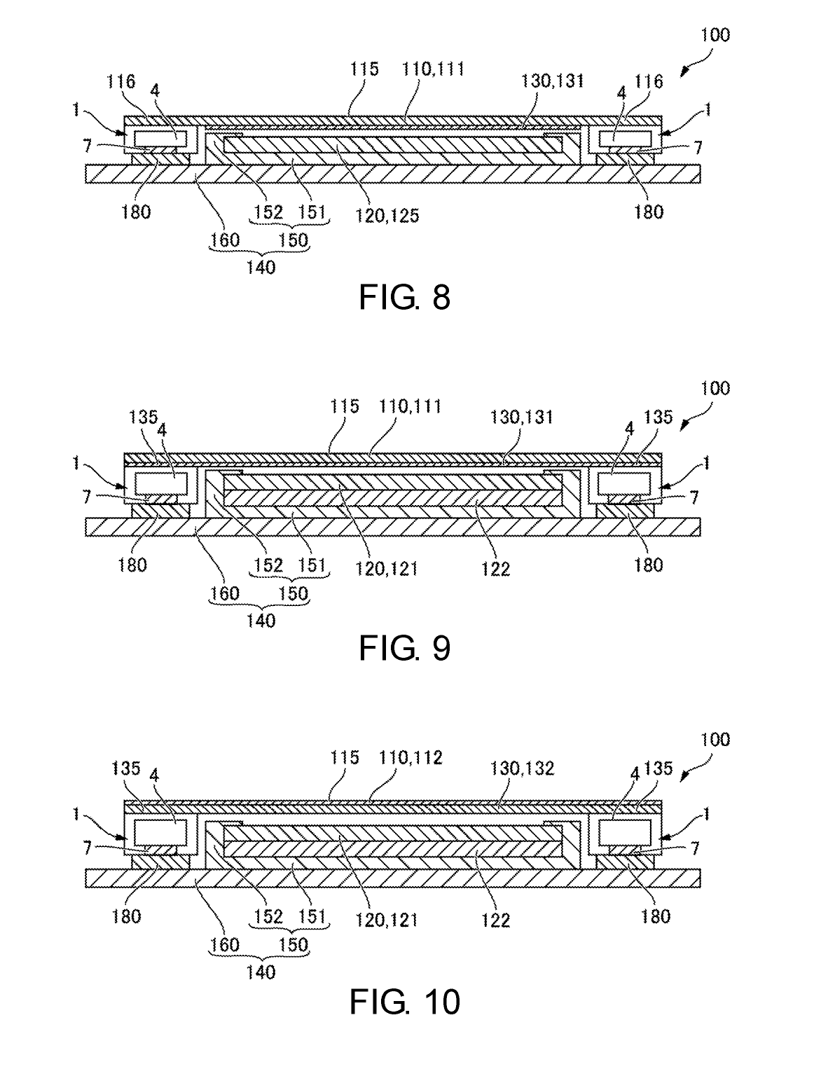

FIG. 8 is a cross-sectional view of a touch panel-equipped display device 100 according to a second embodiment of the first invention. Since the basic configuration of the present embodiment and below-described embodiments is same as that of the first embodiment, the corresponding parts are denoted by the same reference numerals and the description thereof is omitted. In the first embodiment, the display member 120 is the liquid crystal panel 121, but in the present embodiment, as illustrated in FIG. 8, the display member 120 is an organic electroluminescence display device 125. For this reason, the backlight device 122 illustrated in FIG. 2 is not provided. According to such a configuration, unlike a case where the display member 120 is the liquid crystal panel 121, the backlight device 122 is unnecessary, so that it is possible to reduce a thickness of the touch panel-equipped display device 100.

### Third Embodiment

FIG. 9 is a cross-sectional view of the touch panel-equipped display device 100 according to a third embodiment of the first invention. In the first embodiment, the actuator 1 is connected to the input member 110, but in the present embodiment, as illustrated in FIG. 9, since the input member 110 and the touch panel 130 are equal in size, the actuator 1 is connected to an end 135 of the touch panel 130. Further, the input member 110 and the touch panel 130 are fixed with an adhesive or the like. Therefore, since the vibration of the actuator 1 is transmitted to the input member 110 via the touch panel 130, the vibration of the actuator 1 can be transmitted to the fingertip of the operator.

### Fourth Embodiment

FIG. 10 is a cross-sectional view of the touch panel-equipped display device 100 according to a fourth embodiment of the first invention. In the first embodiment, the touch panel 130 is the capacitive type touch panel 131, but in the present embodiment, as illustrated in FIG. 10, the touch panel 130 is a resistive film type touch panel 132. For this reason, in the present embodiment, a light transmitting sheet 112 is used as the input member 110, and a force of the fingertip can be transmitted to the touch panel 130.

In the thus-configured touch panel-equipped display device 100, the actuator 1 is connected to the end 135 of the touch panel 130 as in the third embodiment. Further, the touch panel 130 and the light transmitting sheet 112 are fixed with an adhesive or the like. Therefore, since the vibration of the actuator is transmitted to the input member 110 via the touch panel 130, the vibration of the actuator 1 can be transmitted to the fingertip of the operator.

### Fifth Embodiment

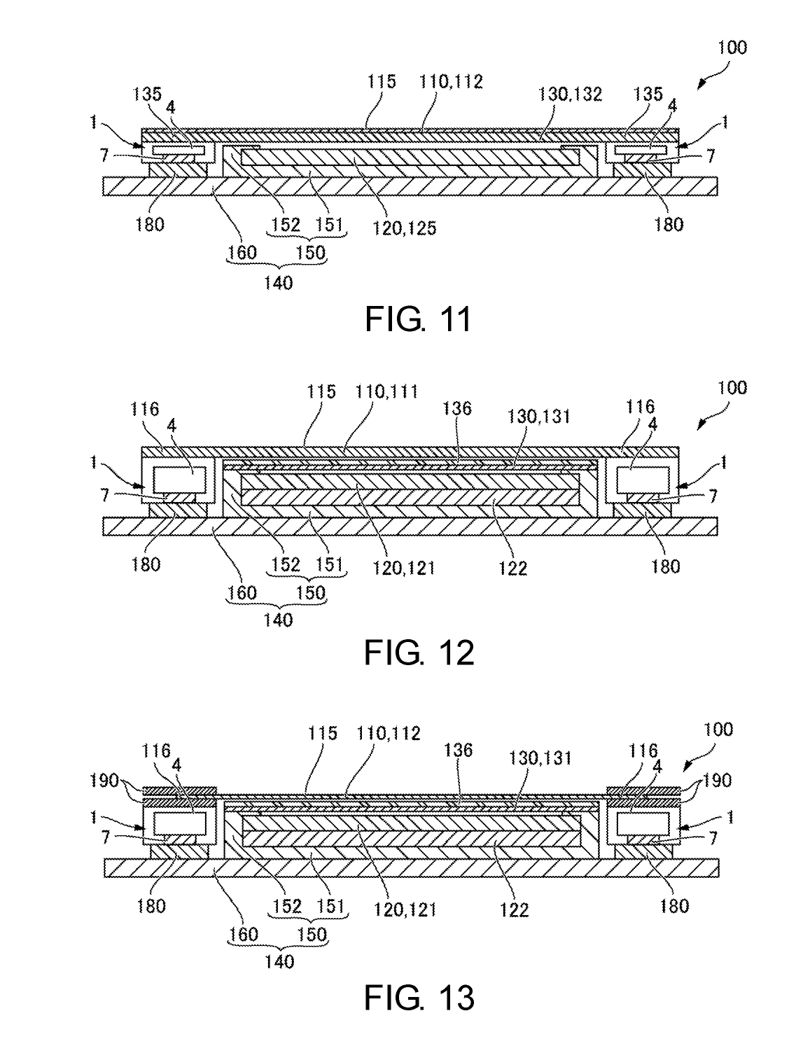

FIG. 11 is a cross-sectional view of the touch panel-equipped display device 100 according to a fifth embodiment of the first invention. In the fourth embodiment, the display member 120 is the liquid crystal panel 121, but in the present embodiment, as illustrated in FIG. 11, the display member 120 is an organic electroluminescence display device 125. For this reason, the backlight device 122 illustrated in FIG. 10 is not provided.

### Sixth Embodiment

FIG. 12 is a cross-sectional view of the touch panel-equipped display device 100 according to a sixth embodiment of the first invention. In the first embodiment, the touch panel 130 is fixed to the input member 110, but in the present embodiment, the touch panel 130 and the input member 110 are spaced apart each other, and the touch panel 130 is fixed to the first holder 150 of the panel holder 140. Further, a plate-like cover 136 made of a cover glass, a light transmitting resin plate or the like is adhered to the touch panel 130, but the plate-like cover 136 does not contact the input member 110. Even in this case, since the touch panel 130 is the capacitive type touch panel 131, the operator can perform an input if the operator touches the input surface 115 of the input member 110 with the fingertip.

In such a configuration, since the size of the touch panel 130 is smaller than that of the input member 110, the actuator 1 is connected to the overhang unit 116 of the input member 110 (light transmitting plate 111). In such a configuration, the vibration of the actuator 1 is transmitted to the input member 110, but is not transmitted to the touch panel 130. Therefore, there is an advantage that a power necessary for vibrating the input member 110 can be reduced.

### Seventh Embodiment

FIG. 13 is a cross-sectional view of the touch panel-equipped display device 100 according to a seventh embodiment of the first invention. As illustrated in FIG. 13, similarly to the sixth embodiment, in the present embodiment also, the touch panel 130 and the input member 110 are spaced apart each other, and the touch panel 130 is fixed to the first holder 150 of the panel holder 140. Further, a plate-like cover 136 made of a cover glass, a light transmitting resin plate or the like is adhered to the touch panel 130, but the plate-like cover 136 does not contact the input member 110. Even in this case, since the touch panel 130 is the capacitive type touch panel 131, the operator can perform an input if the operator touches the input surface 115 of the input member 110 with the fingertip.

Here, the input member 110 is the light transmitting sheet 112. Therefore, in the present embodiment, a sheet holder 190 is attached to the overhang unit 116 of the light transmitting sheet 112, and the input member 110 and the actuator 1 are connected via the sheet holder 190. Even in such a configuration, since the vibration of the actuator 1 is transmitted to the input member 110 (light transmitting sheet 112) via the sheet holder 190, the vibration can be transmitted to the fingertip of the operator. Further, although the vibration of the actuator 1 is transmitted to the input member 110, the vibration is not transmitted to the touch panel 130. Therefore, there is an advantage that a power necessary for vibrating the input member 110 can be reduced.

### Eighth Embodiment

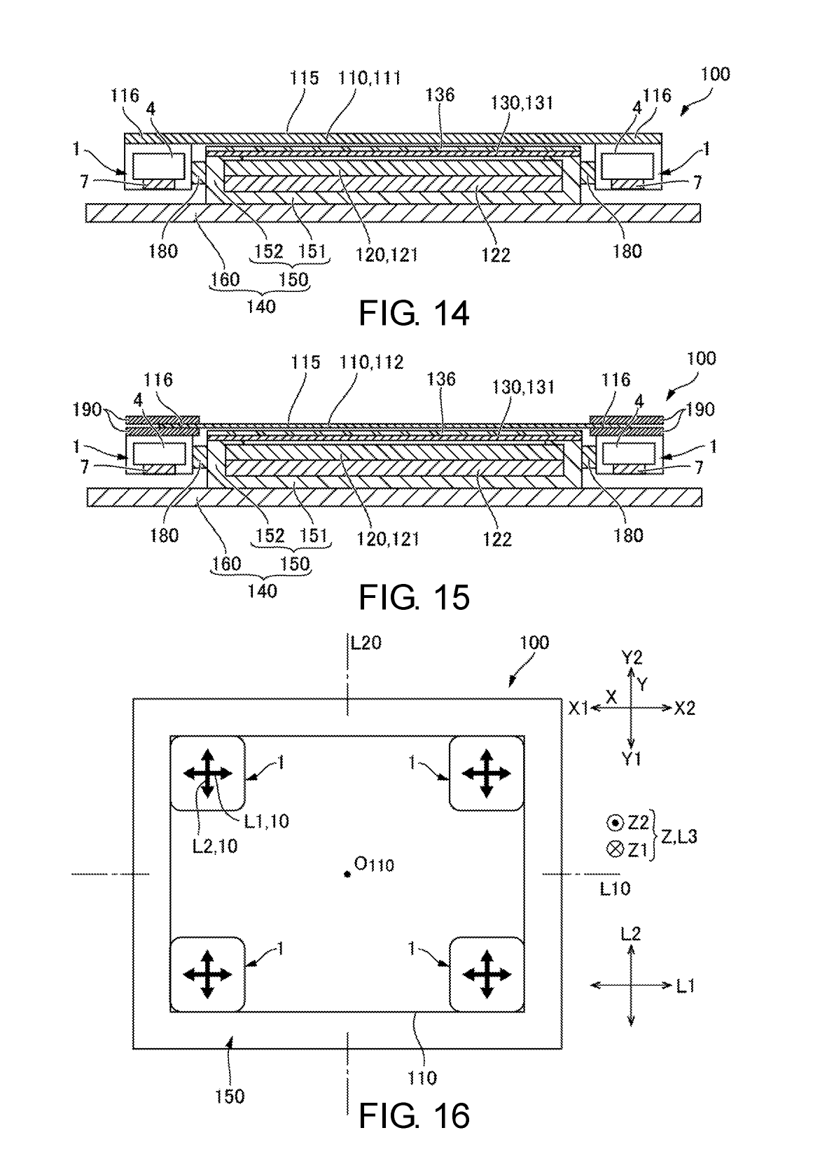

FIG. 14 is a cross-sectional view of the touch panel-equipped display device 100 according to an eighth embodiment of the first invention. As illustrated in FIG. 14, in the present embodiment also, similarly to the sixth embodiment, the touch panel 130 and the input member 110 are spaced apart each other, and the touch panel 130 is fixed to the first holder 150 of the panel holder 140. Therefore, the actuator 1 is connected to the overhang unit 116 of the input member 110 (light transmitting plate 111).

Here, the first elastic member 180 is arranged between the actuator 1 and the side plate portion 152 of the first holder 150 of the panel holder 140. Even in such a configuration, since the actuator 1 is supported by the panel holder 140 via the first elastic member 180, even if the operator strongly presses the input surface 115, the actuator 1 vibrates independently of the panel holder 140. Therefore, it is possible to properly transmit the vibration to the operator.

### Ninth Embodiment

FIG. 15 is a cross-sectional view of the touch panel-equipped display device 100 according to a ninth embodiment of the first invention. As illustrated in FIG. 15, in the present embodiment also, similarly to the seventh embodiment, the touch panel 130 and the input member 110 are spaced apart each other, and the touch panel 130 is fixed to the first holder 150 of the panel holder 140. Therefore, the actuator 1 is connected to the input member 110 (light transmitting sheet 112) via the sheet holder 190.

Here, the first elastic member 180 is arranged between the actuator 1 and the side plate portion 152 of the first holder 150 of the panel holder 140. Even in such a configuration, since the actuator 1 is supported by the panel holder 140 via the first elastic member 180, even if the operator strongly presses the input surface 115, the actuator 1 vibrates independently of the panel holder 140. Therefore, it is possible to properly transmit the vibration to the operator.

### Tenth Embodiment

FIG. 16 is an explanatory diagram illustrating a layout of the actuator 1 in the touch panel-equipped display device 100 according to a tenth embodiment of the first invention. In the first embodiment and the like, a total of four actuators 1 are respectively arranged near the center of the four sides of the input member 110, but in the present embodiment, as illustrated in FIG. 16, a total of four actuators 1 are arranged respectively at four corners of the input member 110. Therefore, the plurality of actuators are arranged point-symmetrically about the center position O110 of the input member 110. Further, the plurality of actuators are arranged line-symmetrically about the first imaginary line L10 extending in the first direction L1 (X-axis direction) and passing through the center position O110 of the input member 110, and are arranged line-symmetrically about the second imaginary line L20 extending in the second direction L2 (Y-axis direction) and passing through the center position O110 of the input member 110.

### Eleventh Embodiment

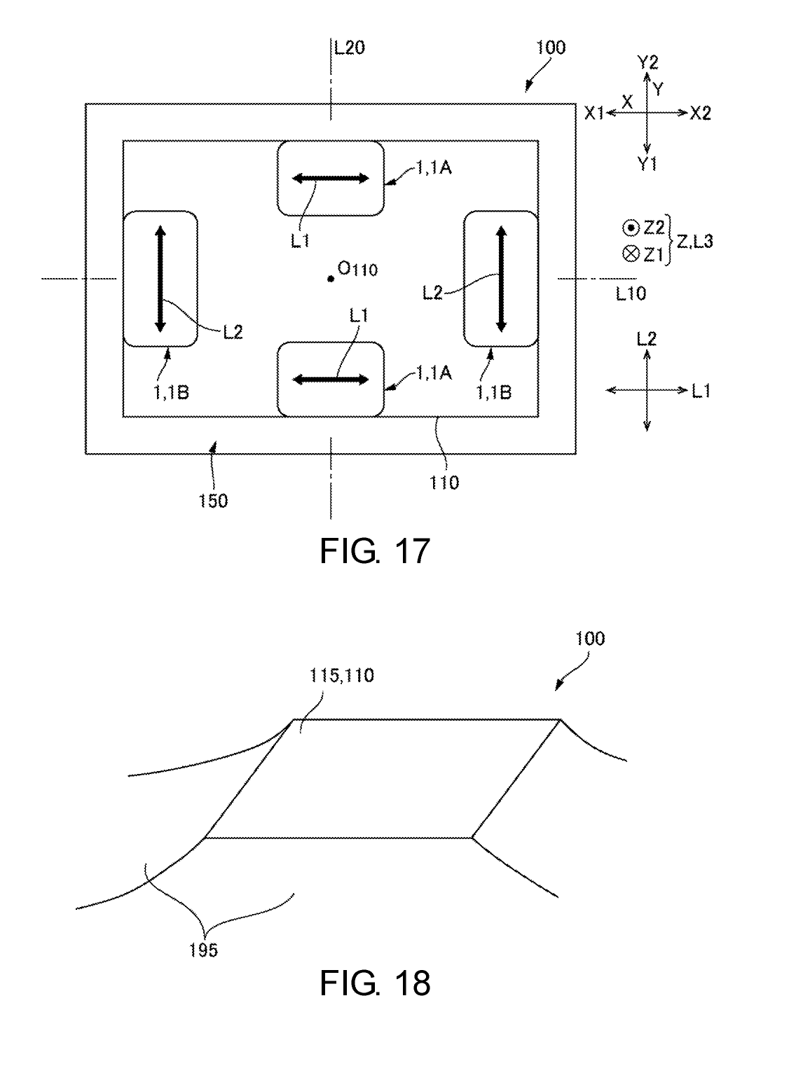

FIG. 17 is an explanatory diagram of the actuator 1 used in the touch panel-equipped display device 100 according to an eleventh embodiment of the first invention. In the first embodiment, one actuator 1 generates the vibrations in two directions, but in the present embodiment, as illustrated in FIG. 17, the plurality of actuators 1 include a first actuator 1A in which the magnetic drive circuit drives the movable body 4 in the first direction L1 with respect to the support body 5, and a second actuator 1B in which the magnetic drive circuit drives the movable body 4 in the second direction L2 with respect to the support body 5. Even in such a configuration, with the help of the first actuator 1A and the second actuator 1B, the vibration in the first direction L1, the vibration in the second direction L2, and the vibration obtained by combining the vibration in the first direction L1 and the vibration in the second direction L2 can be transmitted to the fingertip of the operator.

### Twelfth Embodiment

FIG. 18 is an explanatory diagram of the touch panel-equipped display device 100 according to a twelfth embodiment of the first invention. In a structure illustrated in the first embodiment or the like, the gap between the input member 110 and the panel holder 140 is opened, but in the present embodiment, as illustrated in FIG. 18, a circumference of the input surface 115 is covered with a diaphragm-like flexible sheet 195. For this reason, it is possible to prevent foreign matters or the like from entering between the input member 110 and the panel holder 140 illustrated in FIG. 2 and the like.

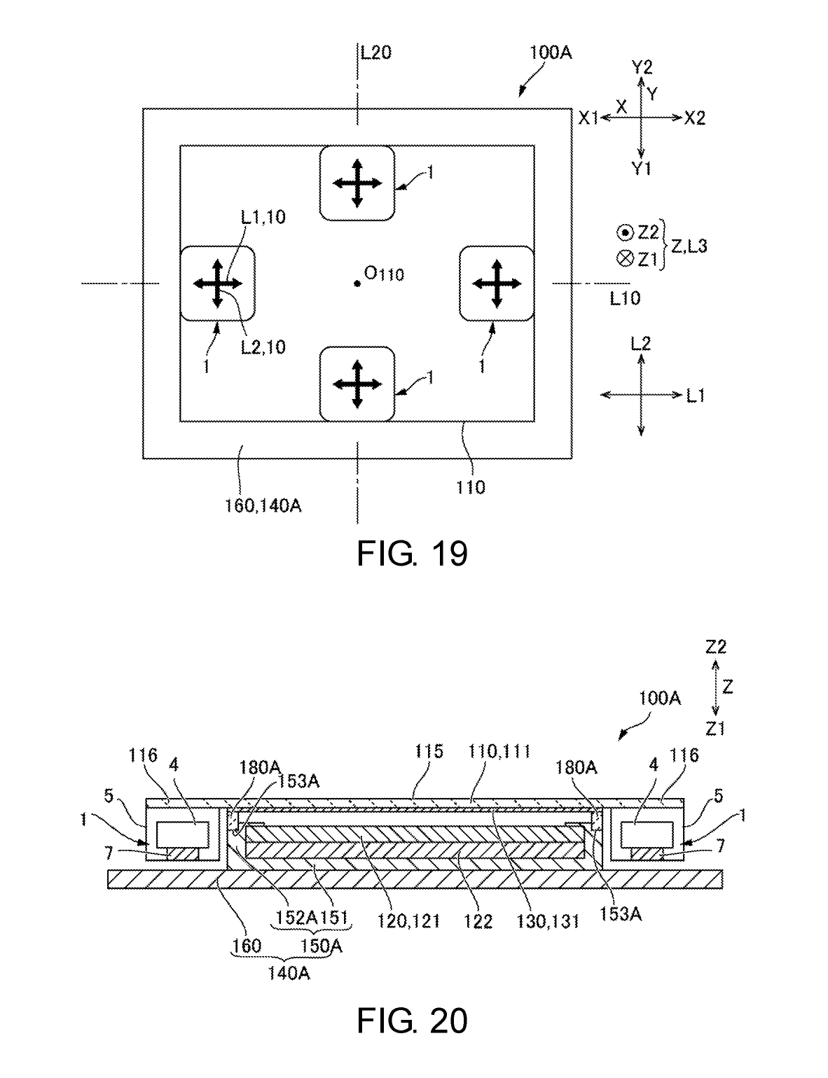

Next, embodiments of a second invention will be described with reference to FIG. 19 to FIG. 27. A touch panel-equipped display device 110A described below has the same basic configuration as that of the touch panel-equipped display device 100 of the first invention described above, and then common parts are denoted by the same reference numerals. Further, since the actuator 1 used for the touch panel-equipped display device 110A has the same basic configuration as that of the actuator 1 described in the first invention, common parts are denoted by the same reference numerals and will not be described. It is noted that in the following description, for the purpose of clarifying a layout and the like of the touch panel-equipped display device 100A and the actuator 1, description proceeds where mutually crossing directions are defined as an X-axis direction, a Y-axis direction, and a Z-axis direction, where one side in the X-axis direction is X1, the other side in the X-axis direction is X2, one side in the Y-axis direction is Y1, the other side in the Y-axis direction is Y2, one side in the Z-axis direction is Z1, and the other side in the Z-axis direction is Z2. In addition, the X-axis direction and the Y-axis direction are directions along an input surface for a touch panel, and the Z-axis direction is a normal direction to the input surface. Further, in the drawings referred to in the following description, the scales for each layer and each member are differed such that each member is recognizable on the drawing.

### First Embodiment

### (Configuration of Touch Panel-Equipped Display Device 100A)

FIG. 19 is an explanatory diagram illustrating an example of a planar configuration of the touch panel-equipped display device 100A according to a first embodiment of the second invention. FIG. 20 is a cross-sectional view of the touch panel-equipped display device 100A illustrated in FIG. 19. In FIG. 19, the vibration direction generated by each actuator 1 is indicated by thick arrows. The touch panel-equipped display device 100A illustrated in FIG. 19 and FIG. 20 includes the display member 120, the light transmitting touch panel 130 arranged to overlap on the other side Z2 in the Z-axis direction relative to the display member 120, and a panel holder 140A configured to support the display member 120. In the preset embodiment, the display member 120 is a liquid crystal panel 121, and a backlight device 122 is arranged on the opposite side of the touch panel 130 relative to the liquid crystal panel 121. The panel holder 140A includes a first holder 150A configured to house therein the display member 120 and the backlight device 122, and the second holder 160 configured to support the first holder 150A on the opposite side of the display member 120 (one side Z1 in the Z-axis direction). The first holder 150A includes the bottom plate 151 configured to support the display member 120 and the backlight device 122 on the one side Z1 in the Z-axis direction, and a side plate portion 152A configured to surround the display member 120 and the backlight device 122. The second holder 160 has a plate shape.

The touch panel-equipped display device 100A includes the light transmitting input member 110 configuring the input surface 115 for the touch panel 130, and a plurality of actuators 1 configured to transmit vibration in the in-plane direction of the input surface 115 for the input member 110. The input member 110 is supported by the panel holder 140A via the first elastic member 180A, and is capable of vibrating in the in-plane direction of the input surface 115.

In the present embodiment, the touch panel 130 is a capacitive type touch panel 131, and the input member 110 is formed of the light transmitting plate 111. Further, the touch panel 130 and the input member 110 (light transmitting plate 111) are fixed with an adhesive or the like. Here, the input member 110 and the touch panel 130 do not contact the panel holder 140A.

The input member 110 has a larger size than the touch panel 130 and has an overhang unit 116 overhang from the touch panel 130 in the in-plane direction along the input surface 115. In the present embodiment, in the input member 110, the actuators 1 are connected to the overhang unit 116 overhanging from the touch panel 130 and are not connected to the panel holder 140A.

Further, any of the plurality of actuators 1 is connected to a rear surface side (one side Z1 in the Z-axis direction) where the display member 120 is positioned with respect to the overhang unit 116, and when viewed from the Z-axis direction, the actuator 1 and the first elastic member 180A overlap with the overhang unit 116. Therefore, when viewed from the Z-axis direction, the actuators 1 and the first elastic member 180A do not overhand outward from the input member 110.

The first elastic member 180A is arranged to be connected to the touch panel 130 and the side plate portion 152A of the panel holder 140A. Therefore, the input member 110 is supported by the panel holder 140A via the first elastic member 180A and the touch panel 130, and can vibrate together with the touch panel 130 in the in-plane direction of the input surface 115. A step portion 153A recessed toward the opposite side of the input member 110 is formed in the side plate portion 152A of the panel holder 140A, and the first elastic member 180A is arranged in the step portion 153A. Therefore, it is possible to reduce the thickness of the touch panel-equipped display device 100A.

The first elastic member 180A has at least one of elasticity and viscoelasticity. In the present embodiment, the first elastic member 180A is made of a viscoelastic body. Examples of the viscoelastic body to be employed may include various types of rubber materials and a modified material thereof including natural rubber, diene-based rubber (such as styrene-butadiene rubber, isoprene rubber, butadiene rubber, chloroprene rubber and acrylonitrile-butadiene rubber), non-diene rubber (such as butyl rubber, ethylene-propylene rubber, ethylene-propylene-diene rubber, urethane rubber, silicone rubber, and fluororubber), and a thermoplastic elastomer. Further, as the viscoelastic body, gel such as silicone gel can be used.

Here, an entire circumference of the first elastic member 180A is formed continuously. Therefore, it is possible to prevent foreign matters or the like from entering between the touch panel 130 and the display member 120.

In the present embodiment, as described with reference to FIG. 3 to FIG. 7, the actuator 1 includes the support body 5 configured to transmit vibration to the input member 110, the movable body 4, the second elastic member 7 connected to the support body 5 and the movable body 4, and a magnetic drive circuit (not illustrated) configured to drive the movable body 4 relative to the support body 5, and the movable body 4 is supported by the support body 5 via the second elastic member 7. The actuator 1 generates vibrations in two mutually orthogonal directions (a first direction L1 and a second direction L2), as described above. In the present embodiment, the drawings are so prepared that the first direction L1 is a direction along the X-axis direction and the second direction L2 is a direction along the Y-axis direction.

In the touch panel-equipped display device 100A, each of the plurality of actuators 1 transmits the vibration in the first direction L1 along the X-axis direction and the vibration in the second direction L2 along the Y-axis direction, to the input member 110. In the present embodiment, when viewed from the third direction L3 along the Z-axis direction, the plurality of actuators 1 are arranged around the center position O110 of the input member 110. A planar shape of the input member 110 is a quadrangle. More specifically, the planar shape of the input member 110 is an oblong rectangle, and a total of four actuators 1 are arranged near a center of four sides of the input member 110. Therefore, when viewed from the Z-axis direction, the plurality of actuators 1 are arranged point-symmetrically about the center position O110 of the input member 110. Further, the plurality of actuators 1 are arranged line-symmetrically about the first imaginary line L10 extending in the X-axis direction and passing through the center position O110 of the input member 110, and are arranged line-symmetrically about the second imaginary line L20 extending in the Y-axis direction and passing through the center position O110 of the input member 110.

### (Operation in Touch Panel-Equipped Display Device 100A)

In the thus-configured touch panel-equipped display device 100A, if a predetermined position on the input surface 115 is touched with a fingertip, a controller (not illustrated) drives the plurality of actuators 1. Therefore, the vibration output from the actuators 1 is transmitted to the input member 110. Therefore, it is possible to transmit the vibration to the fingertip of an operator. At that time, if the vibration in the X-axis direction is generated in any of the plurality of actuators 1, the operator feels the vibration in the X-axis direction. Further, if the vibration in the Y-axis direction is generated in any of the plurality of actuators 1, the operator feels the vibration in the Y-axis direction. At this time, for example, in the vibration in the Y-axis direction, if the acceleration of vibration is differed between when the fingertip moves to the one side Y1 of the Y-axis and when the fingertip moves to the other side Y2 thereof, the operator will feel vibration having directionality in the Y-axis direction. Further, from among the plurality of actuators 1, the actuator 1 positioned on the opposite side across the center position O110 may generate vibration having directionality in the opposite direction around the center position O110. In this case, the operator will feel the vibration having directionality toward one side around the center position O110 from the input member 110.

### (Example of Specific Configuration of Actuator 1)

A basic configuration of the actuator 1 used in the touch panel-equipped display device 100A illustrated in FIG. 19 and the like is the same as that of the actuator 1 described above. Therefore, since the actuator 1 used in the touch panel-equipped display device 100A has substantially the same configuration as the actuator 1 illustrated in FIG. 3 to FIG. 7, the common components are denoted by the same reference numerals and the detailed description is omitted. That is, since the actuator 1 used in the touch panel-equipped display device 100A is as described in the first invention, a detailed description thereof will be omitted. It is noted that the actuator 1 described in the second invention generates vibrations in two mutually orthogonal directions (the first direction L1 and the second direction L2), and in the following description, illustration is prepared so that the first direction L1 is a direction along the X-axis direction and the second direction L2 is a direction along the Y-axis direction. Further, in the actuator 1, the third direction L3 is a direction along the Z-axis direction.

### (Operation or the Like in Actuator 1)

Likewise, description of the operation of the actuator 1 or the like used in the touch panel-equipped display device 100A is substantially similar to that of the actuator 1 illustrated in FIG. 3 to FIG. 7, so detailed description thereof will be omitted.

### Main Effect of Present Embodiment

As described above, in the touch panel-equipped display device 100A of the present embodiment, the input member 110 configuring the input surface 115 for the touch panel 130 is supported by the panel holder 140A via the first elastic member 180A, and the actuator 1 transmits the vibration in the in-plane direction of the input surface 115, to the input member 110. Therefore, the operator touching the input surface 115 can be made to feel the vibration via the input member. Further, since the actuator 1 is not connected to the panel holder 140A and transmits the vibration to the input member 110, even if the operator strongly presses the input surface 115, the actuator 1, which vibrates independently of the panel holder 140A, can properly transmit the vibration to the operator.

In addition, the actuator 1 and the first elastic member 180A are provided to overlap with the input member 110 on a side where the display member 120 is positioned with respect to the input member 110. Therefore, since the actuator 1 and the first elastic member 180A do not exist around the input member 110A, it is easy to adopt a mode in which a peripheral region around the input member 110 is narrowed, a mode in which another member is arranged, or the like.

Further, there are a plurality of actuators 1, and thus, it is possible to achieve a mode in which strong vibrations in the same direction are transmitted to the operator by the plurality of actuators 1, and a mode in which vibrations in different directions are transmitted to the operator by the plurality of actuators 1. In addition, since the plurality of actuators 1 are arranged around the center position O110 of the input member 110 when viewed from the third direction L3 (the Z-axis direction), the vibration generated by the plurality of actuators 1 can be effectively transmitted to the common input member 110, and when different vibrations are generated by the plurality of actuators 1, the common input member 110 can be made to vibrate with a sense of creativity. Particularly, in the present embodiment, when viewed from the Z-axis direction orthogonal to the input surface 115, the plurality of actuators 1 are arranged point-symmetrically about the center position O110 of the input member 110 or line-symmetrically about the imaginary line passing through the center position O110. Therefore, the vibrations generated by the plurality of actuators 1 can be efficiently transmitted to the common input member 110, and when the different vibrations are generated by the plurality of actuators 1, the common input member 110 can be made to vibrate with a sense of creativity.

Further, in the actuator 1, since the movable body 4 is supported by the support body 5 via the second elastic member 7, the vibration can be transmitted to the input member 110 via the support body 5 of the actuator 1. Even in that case, since the support body 5 of the actuator 1 is not connected to the panel holder 140A, the vibration can be transmitted to the input member 110 via the support body 5 of the actuator 1.

Further, each of the plurality of actuators 1 includes the first magnetic drive circuit 10 configured to vibrate the movable body 4 in the first direction L1 and the second magnetic drive circuit 20 configured to vibrate the movable body 4 in the second direction L2. Therefore, when the different vibrations are generated by the plurality of actuators 1, the common input member 110 can be made to vibrate with a sense of creativity.

### Second Embodiment

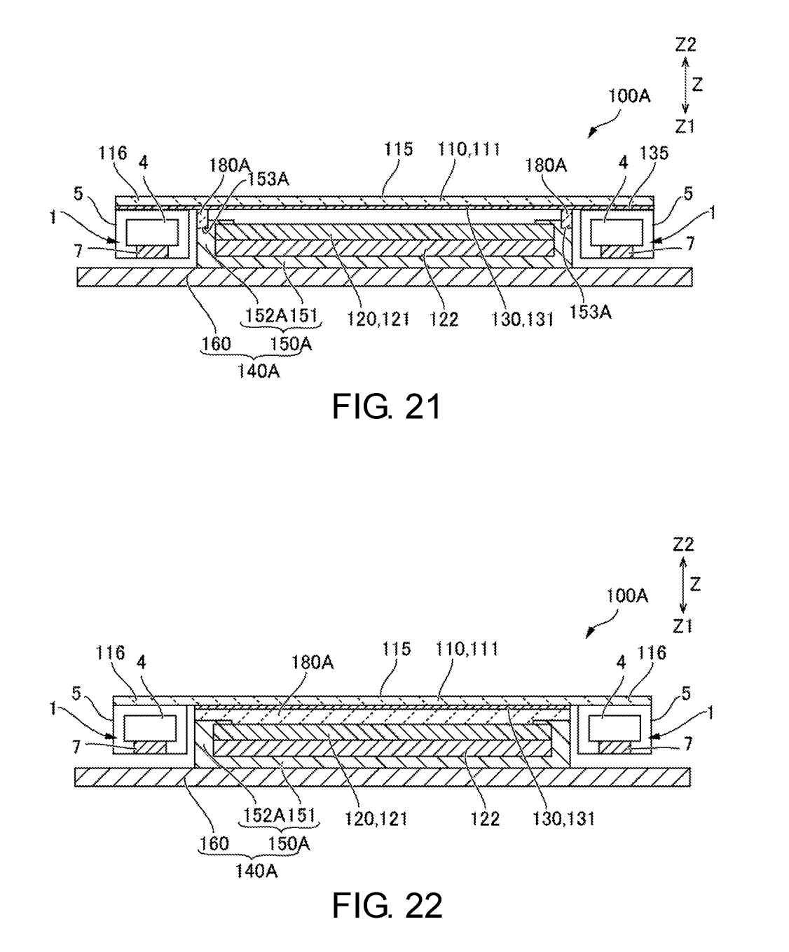

FIG. 21 is a cross-sectional view of the touch panel-equipped display device 100A according to a second embodiment of the second invention. Since the basic configuration of the present embodiment and below-described embodiments is same as that of the first embodiment, the corresponding parts are denoted by the same reference numerals and the description thereof is omitted. In the first embodiment, the actuator 1 is connected to the input member 110, but in the present embodiment, as illustrated in FIG. 21, since the input member 110 and the touch panel 130 are equal in size, the actuator 1 is connected to the end 135 of the touch panel 130. Further, the input member 110 and the touch panel 130 are fixed with an adhesive or the like. Therefore, since the vibration of the actuator 1 is transmitted to the input member 110 via the touch panel 130, the vibration of the actuator 1 can be transmitted to the fingertip of the operator.

### Third Embodiment

FIG. 22 is a cross-sectional view of the touch panel-equipped display device 100A according to a third embodiment of the second invention. In the first embodiment, the first elastic member 180A is arranged to be connected to the touch panel 130 and the side plate portion 152 A of the panel holder 140A, but in the present embodiment, as illustrated in FIG. 22, the first elastic member 180A is arranged to fill a gap between the display member 120 and the touch panel 130. Therefore, the first elastic member 180A is made of a light transmitting material. Further, the input member 110 and the touch panel 130 are fixed with an adhesive or the like. Therefore, the input member 110 is supported by the panel holder 140A via the touch panel 130, the first elastic member 180A, and the display member 120. Further, the first elastic member 180A is arranged to fill a gap between the side plate portion 152A of the panel holder 140A and the touch panel 130. Therefore, the input member 110 is supported by the panel holder 140A via the touch panel 130 and the first elastic member 180A. Even in such a configuration, as in the first embodiment, since the vibration of the actuator 1 is transmitted to the input member 110 via the touch panel 130, the vibration of the actuator 1 can be transmitted to the fingertip of the operator.

Further, between the display member 120 and the touch panel 130, there is no interface between the display member 120 and an air space or an interface between the touch panel 130 and the air space. Therefore, between the display member 120 and the touch panel 130, reflection at the interface of the display member 120 or the touch panel 130 can be suppressed.

### Fourth Embodiment

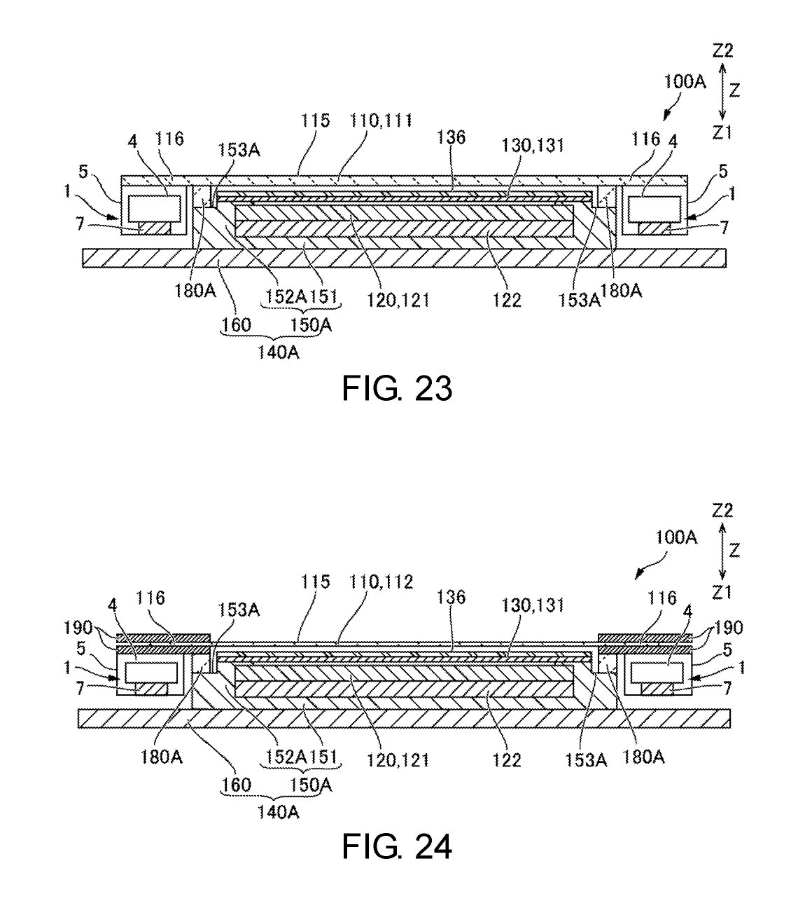

FIG. 23 is a cross-sectional view of the touch panel-equipped display device 100A according to a fourth embodiment of the second invention. In the first embodiment, the touch panel 130 is fixed to the input member 110, but in the present embodiment, as illustrated in FIG. 23, the touch panel 130 and the input member 110 are spaced apart each other, and the touch panel 130 is fixed to the first holder 150A of the panel holder 140A. Further, a plate-like cover 136 made of a cover glass, a light transmitting resin plate or the like is adhered to the touch panel 130, but the plate-like cover 136 does not contact the input member 110. Even in this case, since the touch panel 130 is the capacitive type touch panel 131, the operator can perform an input if the operator touches the input surface 115 of the input member 110 with the fingertip.

Further, in the present embodiment, the first elastic member 180A is arranged to be connected to the input member 110 and the side plate portion 152A of the panel holder 140A, and does not contact the touch panel 130. Further, the actuator 1 is connected to the overhang unit 116 of the input member 110. In such a configuration, the vibration of the actuator 1 is transmitted to the input member 110, but is not transmitted to the touch panel 130. Therefore, in the actuator 1, there is an advantage that a power required for vibrating the input member 110 can be reduced. In addition, if the entire circumference of the first elastic member 180A is formed continuously, it is possible to suppress foreign matters or the like from entering between the input member 110 and the touch panel 130.

### Fifth Embodiment

FIG. 24 is a cross-sectional view of the touch panel-equipped display device 100A according to a fifth embodiment of the second invention. As illustrated in FIG. 24, in the present embodiment also, similarly to the fourth embodiment, the touch panel 130 and the input member 110 are spaced apart each other, and the touch panel 130 is fixed to the first holder 150A of the panel holder 140A. Further, a plate-like cover 136 made of a cover glass, a light transmitting resin plate or the like is adhered to the touch panel 130, but the plate-like cover 136 does not contact the input member 110. Even in this case, since the touch panel 130 is the capacitive type touch panel 131, the operator can perform an input if the operator touches the input surface 115 of the input member 110 with the fingertip.

In the present embodiment, the input member 110 is the light transmitting sheet 112. Therefore, in the present embodiment, a sheet holder 190 is attached to the overhang unit 116 of the light transmitting sheet 112, and the input member 110 and the actuator 1 are connected via the sheet holder 190. Further, in the present embodiment, the first elastic member 180A is arranged between the sheet holder 190 and the side plate portion 152A of the panel holder 140A. Therefore, the input member 110 is supported by the panel holder 140A via the first elastic member 180A and the sheet holder 190.

Even in such a configuration, since the vibration of the actuator 1 is transmitted to the input member 110 (light transmitting sheet 112) via the sheet holder 190, the vibration can be transmitted to the fingertip of the operator. Further, although the vibration of the actuator 1 is transmitted to the input member 110, the vibration is not transmitted to the touch panel 130. Therefore, there is an advantage that a power necessary for vibrating the input member 110 can be reduced. Further, since the input member 110 is formed of the light transmitting sheet 112, there is an advantage that in the actuator 1, the power required for vibrating the input member 110 can be reduced.

### Sixth Embodiment

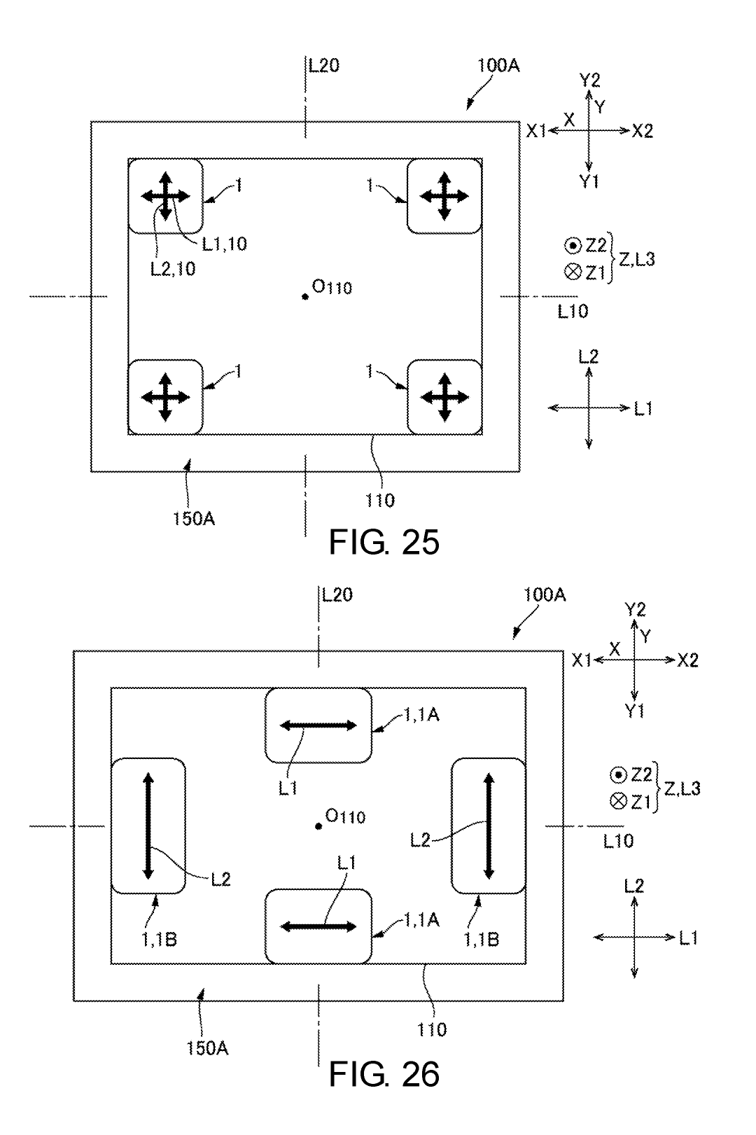

FIG. 25 is an explanatory diagram illustrating a layout of the actuator 1 in the touch panel-equipped display device 100A according to a sixth embodiment of the second invention. In the first embodiment and the like, a total of four actuators 1 are respectively arranged near the center of the four sides of the input member 110, but in the present embodiment, as illustrated in FIG. 25, a total of four actuators 1 are arranged respectively at four corners of the input member 110. Therefore, the plurality of actuators are arranged point-symmetrically about the center position O110 of the input member 110. Further, the plurality of actuators are arranged line-symmetrically about the first imaginary line L10 extending in the first direction L1 (X-axis direction) and passing through the center position O110 of the input member 110, and are arranged line-symmetrically about the second imaginary line L20 extending in the second direction L2 (Y-axis direction) and passing through the center position O110 of the input member 110.

### Seventh Embodiment

FIG. 26 is an explanatory diagram of the actuator 1 used in the touch panel-equipped display device 100A according to a seventh embodiment of the second invention. In the first embodiment, one actuator 1 generates the vibrations in two directions, but in the present embodiment, as illustrated in FIG. 26, the plurality of actuators 1 include a first actuator 1A in which the magnetic drive circuit drives the movable body 4 in the first direction L1 with respect to the support body 5, and a second actuator 1B in which the magnetic drive circuit drives the movable body 4 in the second direction L2 with respect to the support body 5. Even in such a configuration, with the help of the first actuator 1A and the second actuator 1B, the vibration in the first direction L1, the vibration in the second direction L2, and the vibration obtained by combining the vibration in the first direction L1 and the vibration in the second direction L2 can be transmitted to the fingertip of the operator.

### Eighth Embodiment

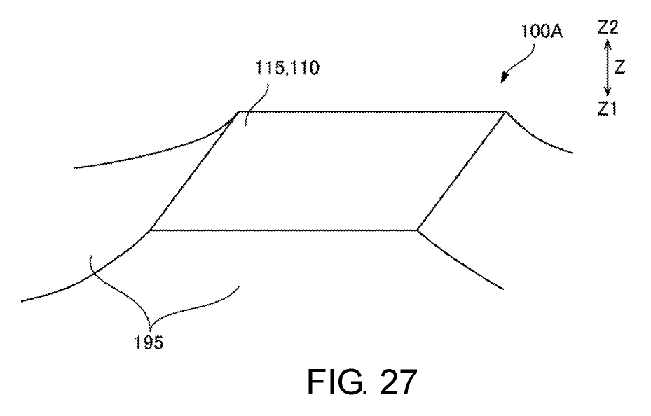

FIG. 27 is an explanatory diagram of the touch panel-equipped display device 100A according to an eighth embodiment of the second invention. In the first to seventh embodiments, if the first elastic member 180A is not provided over the entire circumference, the gap between the input member 110 and the panel holder 140A is partially opened, and in this case, as illustrated in FIG. 27, it is preferable to cover the circumference of the input surface 115 with the diaphragm-like flexible sheet 195. According to such a configuration, it is possible to prevent foreign matters or the like from entering between the input member 110 and the panel holder 140A illustrated in FIG. 20 or the like.

### Other Embodiments

In the embodiments of the second invention, the display member 120 is the liquid crystal panel 121, but the display member 120 may be an organic electroluminescence display device. In this case, it is not necessary to provide the backlight device 122 illustrated in FIG. 20 or the like, so that it is possible to reduce the thickness of the touch panel-equipped display device 100A.

In the first and second embodiments and the like of the second invention, the touch panel 130 is the capacitive type touch panel 131, but if the light transmitting sheet 112 is used for the input member 110, a resistive film type touch panel can be used for the touch panel 130 A.

### DESCRIPTION OF REFERENCE NUMERALS

1 . . . Actuator, 4 . . . Movable body, 5 . . . Support body, 7 . . . Second elastic member, 8 . . . Back yoke, 10 . . . First magnetic drive circuit, 11 . . . First magnet, 12 . . . First coil, 20 . . . Second magnetic drive circuit, 21 . . . Second magnet, 22 . . . Second coil, 56 . . . First case, 57 . . . Second case, 58 . . . Holder, 70 . . . Gel-like damper member, 100 . . . Touch panel-equipped display device, 110 . . . Input member, 111 . . . Light transmitting plate, 112 . . . Light transmitting sheet, 115 . . . Input surface, 120 . . . Display member, 130 . . . Touch panel, 140 . . . Panel holder, 150 . . . First holder, 160 . . . Second holder, 180 . . . First elastic member, 195 . . . Flexible sheet, L1 . . . First direction, L2 . . . Second direction, L10 . . . First imaginary line, L20 . . . Second imaginary line, O110 . . . Center position, 100A . . . Touch panel-equipped display device, 140A . . . Panel holder, 150A . . . First holder, and 180A . . . First elastic member

1. A touch panel-equipped display device, comprising:
a display member;
a touch panel which is light transmitting and arranged to overlap the display member;
a panel holder configured to support the display member;
an actuator configured to transmit a vibration in an in-plane direction of an input surface to an input member configuring the input surface for the touch panel; and
a first elastic member having at least one of elasticity and viscoelasticity and being connected to the actuator and the panel holder,
wherein
the actuator is supported by the panel holder via the first elastic member.

2. The touch panel-equipped display device according to claim 1, wherein the actuator and the first elastic member are provided to overlap with the input member on a side where the display member is positioned with respect to the input member.

3. The touch panel-equipped display device according to claim 1, wherein the actuator comprises a plurality of actuators.

4. The touch panel-equipped display device according to claim 3, wherein viewing from a direction orthogonal to the input surface, the plurality of actuators are arranged point-symmetrically about a center position of the input member or line-symmetrically about an imaginary line passing through the center position.

5. The touch panel-equipped display device according to claim 3, wherein each of the plurality of actuators includes a support body configured to transmit a vibration to the input member; a movable body; a second elastic member having at least one of elasticity and viscoelasticity, the second elastic member being connected to the support body and the movable body; and a magnetic drive circuit configured to drive the movable body relative to the support body in the in-plane direction.

6. The touch panel-equipped display device according to claim 5, wherein each of the plurality of actuators includes, as the magnetic drive circuit, a first magnetic drive circuit configured to drive the movable body in a first direction of the in-plane direction relative to the support body, and a second magnetic drive circuit configured to drive the movable body in a second direction crossing the first direction in the in-plane direction relative to the support body.

7. The touch panel-equipped display device according to claim 5, wherein the plurality of actuators include a first actuator in which the magnetic drive circuit drives the movable body in a first direction of the in-plane direction relative to the support body, and a second actuator in which the magnetic drive circuit drives the movable body in a second direction crossing the first direction in the in-plane direction relative to the support body.

8. The touch panel-equipped display device according to claim 1, wherein the input member is provided to vibrate together with the touch panel, and
the actuator transmits a vibration to at least one of the input member and the touch panel.

9. The touch panel-equipped display device according to claim 1, wherein the input member is provided to be spaced apart from the touch panel, and
the actuator transmits a vibration only to the input member, out of the input member and the touch panel.

10. The touch panel-equipped display device according to claim 1, wherein the input member is a light transmitting plate.

11. The touch panel-equipped display device according to claim 1, wherein the input member is a light transmitting sheet.

12. The touch panel-equipped display device according to claim 1, further comprising a flexible sheet configured to cover a circumference of the input member.

13. A touch panel-equipped display device, comprising:
a display member;
a touch panel which is light transmitting and arranged to overlap the display member;
a panel holder configured to support the display member; and
an actuator configured to transmit a vibration in an in-plane direction of an input surface to an input member configuring the input surface for the touch panel, the actuator not being connected to the panel holder, wherein
the input member is supported by the panel holder via a first elastic member having at least one of elasticity and viscoelasticity.

14. The touch panel-equipped display device according to claim 13, wherein the actuator and the first elastic member are provided to overlap with the input member on a side where the display member is positioned with respect to the input member.

15. The touch panel-equipped display device according to claim 13, wherein the actuator comprises a plurality of actuators.

16. The touch panel-equipped display device according to claim 15, wherein viewing from a direction orthogonal to the input surface, the plurality of actuators are arranged point-symmetrically about a center position of the input member or line-symmetrically about an imaginary line passing through the center position.

17. The touch panel-equipped display device according to claim 15, wherein each of the plurality of actuators includes a support body configured to transmit a vibration to the input member; a movable body; a second elastic member having at least one of elasticity and viscoelasticity, the second elastic member being connected to the support body and the movable body; and a magnetic drive circuit configured to drive the movable body relative to the support body in the in-plane direction.

18. The touch panel-equipped display device according to claim 17, wherein each of the plurality of actuators includes, as the magnetic drive circuit, a first magnetic drive circuit configured to drive the movable body in a first direction of the in-plane direction relative to the support body, and a second magnetic drive circuit configured to drive the movable body in a second direction crossing the first direction in the in-plane direction relative to the support body.

19. The touch panel-equipped display device according to claim 17, wherein the plurality of actuators include a first actuator in which the magnetic drive circuit drives the movable body in a first direction of the in-plane direction relative to the support body, and a second actuator in which the magnetic drive circuit drives the movable body in a second direction crossing the first direction in the in-plane direction relative to the support body.

20. The touch panel-equipped display device according to claim 13, wherein the input member is provided to vibrate together with the touch panel, and
the actuator transmits a vibration to at least one of the input member and the touch panel.

21. The touch panel-equipped display device according to claim 13, wherein the input member is provided to be spaced apart from the touch panel, and
the actuator transmits a vibration only to the input member, out of the input member and the touch panel.

22. The touch panel-equipped display device according to claim 20, wherein the panel holder includes a side plate portion around the display member, and
the first elastic member is connected to the side plate portion.

23. The touch panel-equipped display device according to claim 22, wherein the side plate portion includes a step portion recessed toward an opposite of the input member, and
the first elastic member is connected to the step portion.

24. The touch panel-equipped display device according to claim 20, wherein the first elastic member is arranged to fill a gap between the display member and the touch panel.

25. The touch panel-equipped display device according to claim 13, wherein the input member is a light transmitting plate.

26. The touch panel-equipped display device according to claim 13, wherein the input member is a light transmitting sheet.

27. The touch panel-equipped display device according to claim 13, wherein an entire circumference of the first elastic member is formed continuously.

28. The touch panel-equipped display device according to claim 13, comprising a flexible sheet configured to cover a circumference of the input member.
